(19) United States
(12) Patent Application Publication
(10) Pub. No.: US 2006/0092803 A1
(43) Pub. Date: May 4, 2006

(54) Optical disk apparatus and optical disk reproduction method

(75) Inventors: Yukiyasu Tatsuzawa, Yokohama-shi (JP); Hideyuki Yamakawa, Kawasaki-shi (JP); Koichi Otake, Yokohama-shi (JP); Hiroyuki Moro, Fussa-shi (JP); Toshihiko Kaneshige, Yokohama-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/260,134

(22) Filed: Oct. 28, 2005

(30) Foreign Application Priority Data
Oct. 29, 2004 (JP) 2004-316516

(51) Int. Cl. G11B 20/10

(52) U.S. Cl. 369/59.22

(57) ABSTRACT

A pre-learning section pre-learns whether or not a signal characteristic has been changed by use of at least data in a plurality of data areas, and obtains an optimum equalization coefficient of an adaptive equalizer for the data areas after the signal characteristic has been changed, and then stores the optimum equalization coefficient in a optimum equalization coefficient storage section. On the basis of detection information from a reference information (VFO) area detection section, the optimum equalization coefficient pre-learned in a reference information (VFO) area is preset in the adaptive equalizer, and equalization coefficient learning processing for the adaptive equalizer is started after entering a next data area.

### CROSS-REFERENCE TO RELATED APPLICATIONS

This application is based upon and claims the benefit of priority from prior Japanese Patent Application No. 2004-316516, filed Oct. 29, 2004, the entire contents of which are incorporated herein by reference.

### BACKGROUND OF THE INVENTION

1. Field of the Invention

This invention relates to an optical disk apparatus which reproduces digital data from an optical disk which is an information recording medium, and to an optical disk reproduction method.

2. Description of the Related Art

Recording media which digital data can be recorded on and reproduced from include optical disks represented by digital versatile disks (DVDs).

For example, a DVD-RAM which is one type of DVD comprises a signal recording layer in a disk-shaped medium. By applying laser light having suitable energy to the signal recording layer, the crystal condition of the recording layer can be changed. Thus, information can be retained in the recording layer.

Furthermore, after the information has been recorded in the recording layer, laser light having suitable energy is applied thereto, so that a change in the amount of reflected light can be obtained depending on the crystal condition of the recording layer. Therefore, the digital data can be reproduced by detecting the reflected light.

Recently, a partial response maximum likelihood (PRML) technique has been employed to increase recording density. The technical nature of the PRML technique has been disclosed in documents such as Jpn. Pat. Appln. KOKAI Publication No. 2001-195830, and this technique will be simply described as follows.

A partial response (PR) is a method in which inter-symbol interference (interference between reproduction signals corresponding to adjacently recorded bits) is positively used to compress a necessary signal band, thereby reproducing data. A suitable manner of causing the inter-symbol interference at this point allows division into a plurality of classes. For example, in a case of Class 1, reproduction data is reproduced as 2-bit data “11” for recorded data “1”, and inter-symbol interference is caused to succeeding 1 bit.

Furthermore, a Viterbi decoding method is one kind of so-called maximum likelihood (ML) sequence estimation methods, wherein regulation of the inter-symbol interference owned by a reproduction waveform is utilized effectively, and data is reproduced on the basis of information on a signal amplitude over a plurality of times. For this processing, a synchronous clock is generated which is synchronous with the reproduction signal waveform obtained from a recording medium, and the reproduction waveform itself is sampled in accordance with this clock, and then the reproduction signal waveform is converted into amplitude information. Subsequently, suitable waveform equalization and the like are performed to convert the amplitude information into a predetermined partial response waveform, and then, in a Viterbi decoding section, a maximum likelihood data sequence is output as the reproduction data using past and current sample data.

A method combining the partial response method and the Viterbi decoding method (maximum likelihood decoding method) is called the PRML method. In order to put this PRML technique into practical applications, there are needed a highly accurate adaptive equalization technique for the reproduction signal to have an intended PR-class response, and a highly accurate clock reproduction technique which supports this adaptive equalization technique.

Next, a run-length limiting code used in the PRML technique will be described. In a PRML reproduction circuit, from a signal reproduced from the recording medium itself, a clock synchronous therewith is generated. To generate a stable clock, a recording signal needs to reverse its polarity within a predetermined time. At the same time, the polarity of the recording signal is prevented from being reversed within the predetermined time to decrease the highest frequency of the recording signal. Here, a maximum data length at which the polarity of the recording signal is not reversed is called a maximum run-length, while a minimum data length at which the polarity is not reversed is called a minimum run-length. A modulation regulation in which the maximum run-length is 8 bits and the minimum run-length is 2 bits is called (1, 7) RLL, and a modulation regulation in which the maximum run-length is 8 bits and the minimum run-length is 3 bits is called (2, 7) RLL. Representative modulation/demodulation methods used in the optical disks include the (1, 7) RLL and EFM Plus (U.S. Pat. No. 5,696,505).

In recent years, an optical disk apparatus has been proposed which achieves high capacity using a blue-violet laser. In addition to the use of the blue-violet laser having a short wavelength to achieve the high capacity, the use of the above-mentioned PRML technique is also considered. As a result, linear recording density can be increased and inventive measures can be taken for a data recording format to achieve the high capacity.

In the optical disk apparatus as described above, when overwrite processing is performed on a rewritable RAM disk or when incremental write processing is performed on a R-disk in which recording is allowed only once, a 4T-pattern (T is a clock cycle) guard area is used as a margin <<area for connection>>, and recording is thus started from a variable frequency oscillator (VFO) area included in the guard area, thereby executing linking processing.

Thus, user data can be seamlessly recorded. However, for example, when different optical disk apparatuses are used to perform rewriting before and after the VFO area for one disk, or when different optical disk apparatuses are used to perform incremental writing before and after the VFO area, laser power, a recording compensation method and the like are also different in general, so that there may be a large difference between a signal characteristic of data in a data area recorded before the VFO area and a signal characteristic of data in a data area recorded after the VFO area. The difference in signal characteristics include, for example, a radio-frequency (RF) reproduction signal amplitude amount, an RF offset amount, an RF asymmetry amount, a frequency characteristic of an RF signal, etc.

Thus, when data having a level difference in signal characteristics is reproduced in, for example, a PRML signal processing circuit, it might be impossible to normally read the data during a period of optimizing a control value from a control optimum value before the VFO area to a control optimum value after the VFO area, because there is a difference, before and after the VFO area, in the control optimum values of the respective signal processing circuits, such as a gain control value, an offset control value, an asymmetry control value and an equalization coefficient in an adaptive equalizer. In particular, high-speed leading-in is possible to a certain degree in the VFO area regarding the gain (amplitude) control value, the offset control value and the asymmetry control value. However, for the adaptive equalizer which learns for adaptation of the frequency characteristic to a PR equalization characteristic, learning itself is impossible in the VFO area where a signal is on a specific cycle, and it is thus impossible to run into the data area at an optimum equalization coefficient value <<it is difficult to guide into the data area using the optimum equalization coefficient value>>.

When such a period is long, during which the data cannot be normally read, there remains a problem that correction can not be performed by exceeding a correction range in subsequent error correction processing.

If the correction is impossible, rereading processing takes place in a personal computer (PC) or the like, so that seeking is performed to move to a portion immediately before an error correction code (ECC) block where correction has become impossible, and the control values of the respective signal processing circuits are again optimized, and data reading is retried accordingly. However, since such a flow is merely repeated, normal reading is impossible.

### BRIEF SUMMARY OF THE INVENTION

The present invention provides an optical disk apparatus which has an adaptive equalizer supplied with at least an analog-to-digital-converted output of a reproduction signal, and a maximum likelihood decoder supplied with an output of the adaptive equalizer, to decode the reproduction signal from an information recording medium in which a reference information (VFO) area for a predetermined frequency is formed between a plurality of data (ECC block) areas set on a track, the optical disk apparatus comprising:

an optimum equalization coefficient storage section which stores an optimum equalization coefficient of the adaptive equalizer;

a pre-learning section which pre-learns whether or not a signal characteristic has been changed by use of at least data in the plurality of data areas, and obtains the optimum equalization coefficient of the adaptive equalizer for the data areas after the signal characteristic has been changed, and then stores the optimum equalization coefficient in the optimum equalization coefficient storage section;

a reference information (VFO) area detection section which detects that an area is the reference information (VFO) area; and

a preset control section which presets, on the basis of detection information on the predetermined frequency from the reference information (VFO) area detection section, at least the optimum equalization coefficient pre-learned in the reference information (VFO) area, and starts equalization coefficient learning processing for the adaptive equalizer at least after entering a next data area.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic block diagram showing an optical disk apparatus according to one embodiment of the present invention;

FIG. 2 is a schematic diagram showing a configuration example of an adaptive equalizer of FIG. 1;

FIG. 3 is a schematic diagram showing a configuration example of a VFO area detector of FIG. 1;

FIGS. 4A to 4D are schematic diagrams showing a signal waveform and an operation sequence in the vicinity of a VFO area to explain an operation example of the apparatus according to the present invention;

FIGS. 5A and 5B are schematic diagrams showing examples of an adaptive equalization coefficient to explain the operation example of the apparatus according to the present invention;

FIGS. 6A to 6C are schematic diagrams showing signal waveforms and operation sequences in the vicinity of the VFO area to explain various other operation examples of the apparatus according to the present invention;

FIG. 7 is a schematic diagram showing an optical disk apparatus according to another embodiment of the present invention;

FIG. 8 is a schematic diagram showing an optical disk apparatus according to still another embodiment of the present invention;

FIGS. 9A and 9B are schematic diagrams showing a relation between wobbles and a beam spot on a track of a recording medium, and showing a configuration of a signal processing unit used to obtain a physical address from the wobbles;

FIG. 10 is a schematic diagram showing a signal waveform and an operation sequence in the vicinity of the VFO area to explain an operation example of the apparatus according to another embodiment of the present invention;

FIG. 11 is a schematic diagram showing a data frame serving as a basis for an ECC block;

FIG. 12 is a schematic diagram showing an original configuration of the ECC block;

FIG. 13 is a schematic diagram showing a state where the ECC block has its frame scrambled (arrangement of the scrambled frame);

FIG. 14 is a schematic diagram showing how parity information is interleaved between parity lines in the ECC block;

FIGS. 15A and 15B are schematic diagrams showing recorded data field;

FIG. 16 is a schematic diagram showing contents of a SYNC code;

FIG. 17 is a schematic diagram showing an example of a hierarchical structure of data recorded on the recording medium regardless of its kind (reproduction only/incremental-writable type/rewritable type);

FIG. 18 is a schematic diagram showing a first example of a recording method of a reproduction-only recording medium;

FIG. 19 is a schematic diagram showing a second example of the recording method of the reproduction-only recording medium;

FIG. 20 is a schematic diagram showing a configuration in a guard area shown in FIGS. 18 and 19;

FIGS. 21A to 21E are schematic diagrams to explain a wobble address format on a recording-type medium;

FIG. 22 is a schematic diagram to explain one example of a bit modulation regulation;

FIG. 23 is a schematic diagram showing layout of periodic wobble address positional information (WAP);

FIG. 24 is a schematic diagram showing layout of an address field in the WAP;

FIGS. 25A to 25C are schematic diagrams to explain a method of detecting 1-bit error of three fields in a parity information area, a method of calculating bits in a groove traffic field, and a method of calculating bits in a land traffic field;

FIG. 26 is a schematic diagram showing a binary/gray code conversion method;

FIG. 27 is a schematic diagram showing a wobble data unit (WDU) in a synchronous field;

FIG. 28 is a schematic diagram showing the WDU in an address field;

FIG. 29 is a schematic diagram showing the WDU in a unity field;

FIG. 30A is a schematic diagram showing the WDU of an outside mark;

FIG. 30B is a schematic diagram showing the WDU of an inside mark;

FIG. 31 is a schematic diagram to explain layout of physical segments of a first physical segment of a track;

FIGS. 32A to 32F are schematic diagrams showing one example of a method of recording rewritable data to be recorded on a rewritable information recording medium;

FIG. 33 is a schematic diagram showing layout of a recording cluster;

FIG. 34 is a schematic diagram showing layout of linking which enables linking processing;

FIG. 35 is a schematic diagram showing a configuration example of an information recording/reproduction apparatus;

FIG. 36 is a schematic diagram to explain a detailed configuration around a synchronous code position detection unit;

FIG. 37 is a flowchart showing a method of determining a SYNC frame position in a sector from an order of arrangement of synchronous codes;

FIG. 38 is a schematic diagram showing the method of determining the SYNC frame position in the sector from the order of arrangement of synchronous codes;

FIG. 39 is a schematic diagram showing the method of determining the SYNC frame position in the sector (using a slicer of FIG. 42) from the order of arrangement of synchronous codes;

FIG. 40 is a schematic diagram to explain an abnormal phenomenon judgment and an adaptive processing method when a detection result of a combination pattern of the synchronous code is different from a prediction;

FIG. 41 is a schematic diagram showing a signal detection/signal evaluation circuit used for signal reproduction in a system read-in area;

FIG. 42 is a schematic diagram showing a slicer circuit used for the signal reproduction in the system read-in area;

FIG. 43 is a schematic diagram showing a detection circuit used for the signal reproduction in a data read-in area, a data area and a data read-out area;

FIG. 44 is a schematic diagram to explain a structure of a Viterbi decoder; and

FIG. 45 is a schematic diagram to explain a state transition of a PR (1, 2, 2, 2, 1) channel combined with an ETM code.

### DETAILED DESCRIPTION OF THE INVENTION

Embodiments of the present invention will hereinafter be described using the drawings.

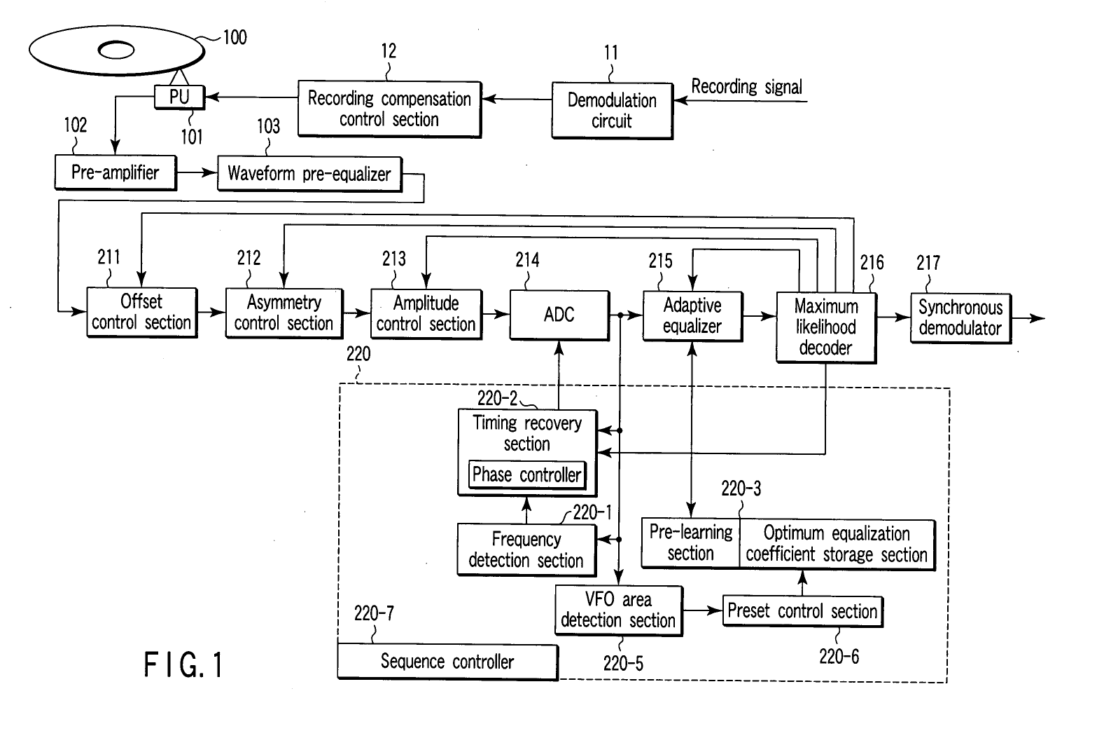

FIG. 1 shows one example of an optical disk apparatus to which the embodiments of this invention are applied. The optical disk apparatus is, as described below in detail, capable of recording digital data in a recording layer of an optical disk which is a recording medium and of reproducing data already recorded therein. It is to be noted that the recorded data can be deleted and new data can be recorded (data is rewritten) depending on the kind of recording medium.

A read channel unit of the optical disk apparatus basically includes an optical disk 100, an optical pickup 101, a pre-amplifier 102, a waveform pre-equalizer 103, an offset control section 211, an asymmetry control section 212, an amplitude control section 213, an analog-to-digital converter (ADC) 214, an adaptive equalizer 215, a maximum likelihood decoder 216, a synchronous demodulator 217, a system control section 220, etc.

The system control unit 220 includes a frequency detection section 220-1, a timing recovery section 220-2, pre-learning section and optimum equalization coefficient storage section 220-3, a VFO area detection section 220-5, and a preset control section 220-6. The system control unit 220 also includes a sequence controller 220-7 to control the operation timing of each block.

When the optical disk 100 is a recordable disk, a recording signal is supplied to a laser driver of the optical pickup 101 via a demodulation circuit 11 and a recording compensation control section 12. Next, processing during reproduction will be described.

Recorded information recorded by a recording pit of the optical disk 100 is read by the optical pickup 101, and converted into a voltage signal (reproduction signal). This reproduction signal is amplified by the pre-amplifier 102, and then subjected to pre-waveform equalization processing by the waveform pre-equalizer 103.

An output of the waveform pre-equalizer 103 has a DC level adjusted in the offset control section 211. This offset control section 211 performs a DC level adjustment suitable for PRML based on an equalization error signal from the maximum likelihood decoder 216 in an ML mode. The next asymmetry control section 212 adjusts asymmetry of the output signal of the offset control section 211. When a signal waveform is vertically asymmetric with reference to a referential level, the asymmetry control section 212 corrects this asymmetry, and perform control to approximate it to symmetry. This asymmetry control section 212 also performs asymmetry adjustment optimal for the PRML based on the equalization error signal from the maximum likelihood decoder 216 in the ML mode.

The amplitude control section 213 adjusts the amplitude of the output signal from the asymmetry control section 213. This amplitude control section 213 also performs amplitude adjustment optimal for the PRML based on the equalization error signal from the maximum likelihood decoder 216 in the ML mode.

The analog-to-digital converter 214 samples the output signal of the amplitude control section 213 at a time based on a sampling clock, and converts it into a digital value.

The adaptive equalizer 215 adaptively equalizes an output signal of the analog-to-digital converter 214 into a predetermined partial response (PR) waveform. A switch is made to decide whether or not to learn a tap coefficient of the adaptive equalizer 215, in accordance with a control signal from the sequence controller 220-7.

The maximum likelihood decoder 216 maximum-likelihood-decodes an adaptively equalized signal on the basis of a predetermined PR class, for example, on the basis of Class PR (3443) to obtain binary data. Here, a recorded data row is recorded as each 1116-bit data called a frame, and the synchronous demodulator 217 detects a 24-bit binary data row (SYNC code) representing a start position of each frame, and generates 12-bit synchronization signals for subsequent decoding processing. The synchronous demodulator 217 demodulates 12-bit binary data into 8-bit reproduction data in accordance with preset rules. At the same time, an amount of error between an ideal level and the adaptively equalized signal is sent, as an equalization error signal, to the blocks including the offset control section 211, the asymmetry control section 212, the amplitude control section 213 and the adaptive equalizer 215.

The timing recovery section 220-2 generates the sampling clock in a phase-synchronous manner with a reproduction signal clock. The timing recovery section 220-2 includes a phase controller. A mode switch is performed in accordance with a control signal from the sequence controller 220-7.

Regarding modes, a switch is made between: a high gain mode which performs phase comparison between an digitized signal and the sampling clock and feeds back a phase error to a sampling clock generator; and the ML mode which performs phase comparison on the basis of a maximum likelihood decoding result and the equalization error signal and performs phase feedback. Further, the timing recovery section 220-2 includes a function to control a frequency of the sampling clock on the basis of a frequency control signal and adjust the frequency into a range in which a phase can be drawn in.

The frequency detection section 220-1 detects a frequency difference between the sampling clock and the reproduction signal clock on the basis of an ADC signal. During frequency detection, a frequency detection signal and a frequency error signal are output.

The synchronous demodulator circuit 217 detects the synchronization signal on the basis of a maximum likelihood decoding output from the maximum likelihood decoder 216. It generates a phase synchronization detection signal when the synchronization signals are sequentially detected at predetermined intervals. The synchronous demodulator 217 also supplies a demodulation output to a next-stage error correction signal and the like (not shown).

A sequencer 230 controls operations of the blocks of the offset control, the asymmetry control, the amplitude control, the timing recovery and the adaptive equalizer, on the basis of the frequency detection signal, the frequency error signal and the phase synchronization detection signal.

Furthermore, the frequency control signal of the sampling clock is generated on the basis of the frequency detection signal and the frequency error signal. When frequency control is turned on, the frequency control signal is generated on the basis of the frequency error signal whenever the frequency detection signal is generated, and a sampling clock frequency is increased or decreased. Phase draw-in is stopped during frequency draw-in, and frequency draw-in is stopped after phase synchronization.

The timing recovery section 220-2 includes a phase-locked loop (PLL) circuit using a digital voltage control oscillator. A frequency-divided output (sampling clock) is maintained in a phase-locked state against a reproduction clock from the outside.

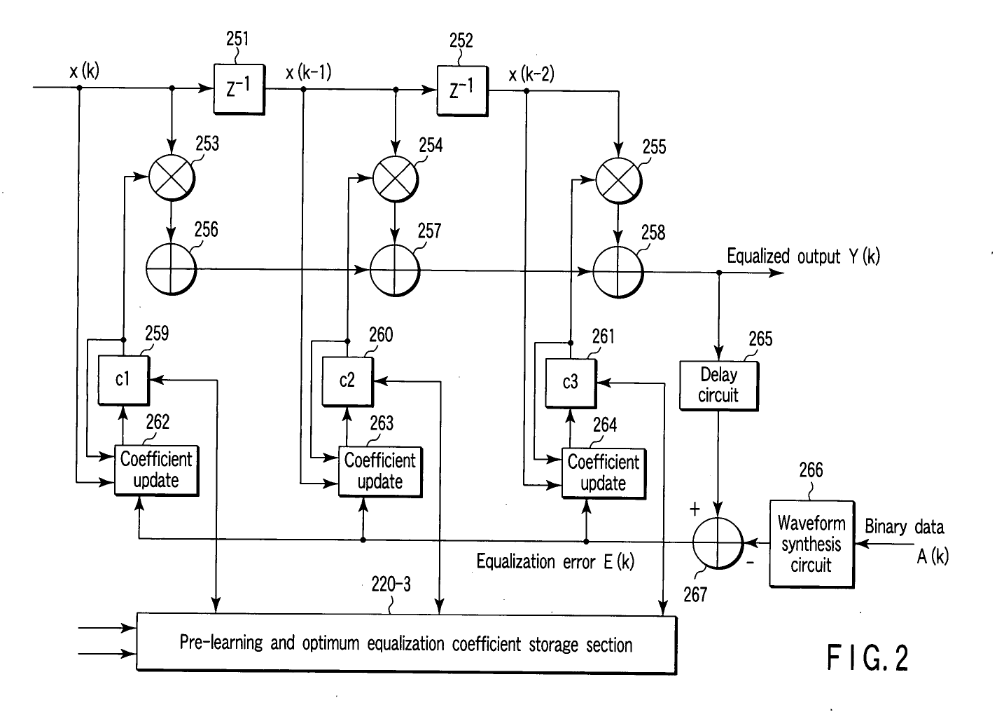

Next, the adaptive equalizer 215 and a learning method of its optimum equalization coefficient will be described using FIG. 2. FIG. 2 is a block diagram showing one example of the adaptive equalizer 215. Numerals 251, 252 denote delay circuits connected in series, and they delay an input signal by one clock and then output it. Numerals 253, 254, 255 denote multipliers. The multiplier 253 outputs a product of an input of the delay circuit 251 and two input values of a register 259. The multiplier 254 outputs a product of an input of the delay circuit 252 and two input values of a register 260. The multiplier 255 outputs a product of an input of the delay circuit 252 and two input values of a register 261.

An addition circuit 256 adds an output of the multiplier 253 and 0. An addition circuit 257 adds an output of the multiplier 254 and an output of the adder 256. An addition circuit 258 adds an output of the multiplier 255 and an output of the adder 257.

While FIG. 2 shows an example of a three-tap digital filter using the three multipliers 253, 254, 255, a basic operation remains the same even if the number of multipliers 253, 254, 255 is changed, and a description will be given only to a three-tap case.

An output Y(k) of the adaptive equalizer 215 can be expressed by
Y(k)=x(k)×c1+x(k−1)×c2+x(k−2)×c3 (1)
wherein x(k) is an input signal of the adaptive equalizer 215 at time k, and multipliers input to the multipliers 253, 254, 255 are c1, c2, c3, respectively.

The binary data obtained in the maximum likelihood (Viterbi) decoder 216 for Y(k) is A(k). An original output Z(k) of the adaptive equalizer 215 at time k is
Z(k)=3A(k)+4A(k−1)+4A(k−2)+3A(k−3)−7 (2)
wherein target PR classes are, for example, PR (3 4 4 3) and A(k) is correct reproduction data.

Therefore, an equalization error E(k) at time k is defined as
E(k)=Y(k)−Z(k) (3).

In adaptive learning, coefficients of the respective multipliers are updated by
c1(k+1)=c1(k)−αx(k)E(k) (4)
c2(k+1)=c2(k)−αx(k−1)E(k) (5)
c3(k+1)=c3(k)−αx(k−2)E(k) (6).

α in Equation (4) to Equation (6) is an update coefficient, for which a small positive value (e.g., 0.01) is set.

Processing in Equation (2) above is performed by a waveform synthesis circuit 266. In a delay circuit 265, an output Y(k) of the addition circuit 258 is delayed by an amount corresponding to processing time by the Viterbi decoding circuit 217. Processing indicated in Equation (3) is performed in the addition circuit 257.

In a coefficient updating circuit 262, a coefficient of the multiplier 253 is updated in accordance with an operation indicated in Equation (4). An update result is stored in the register 259.

In a coefficient updating circuit 263, a coefficient of the multiplier 254 is updated in accordance with an operation indicated in Equation (5). An update result is stored in the register 260.

In a coefficient updating circuit 264, a coefficient of the multiplier 265 is updated in accordance with an operation indicated in Equation (6). An update result is stored in the register 261.

In this way, the adaptive learning of the adaptive equalizer 215 is updated. That is, the optimum equalization coefficient is set. Further, the optimum equalization coefficient obtained during a pre-learning period is stored in the pre-learning section and optimum equalization coefficient storage section 220-3, and put on hold for next reproduction. Moreover, offset control, gain control, adaptive equalization, timing recovery, etc., are adaptively controlled (controlled to produce signal characteristics optimum for PLM decoding) in accordance with an error (equalization error) between an ideal signal obtained by the Viterbi decoder 217 and the input signal, thereby enabling more accurate control.

The optimum equalization coefficient obtained during the pre-learning period is temporarily stored in the pre-learning section and optimum equalization coefficient storage section 220-3.

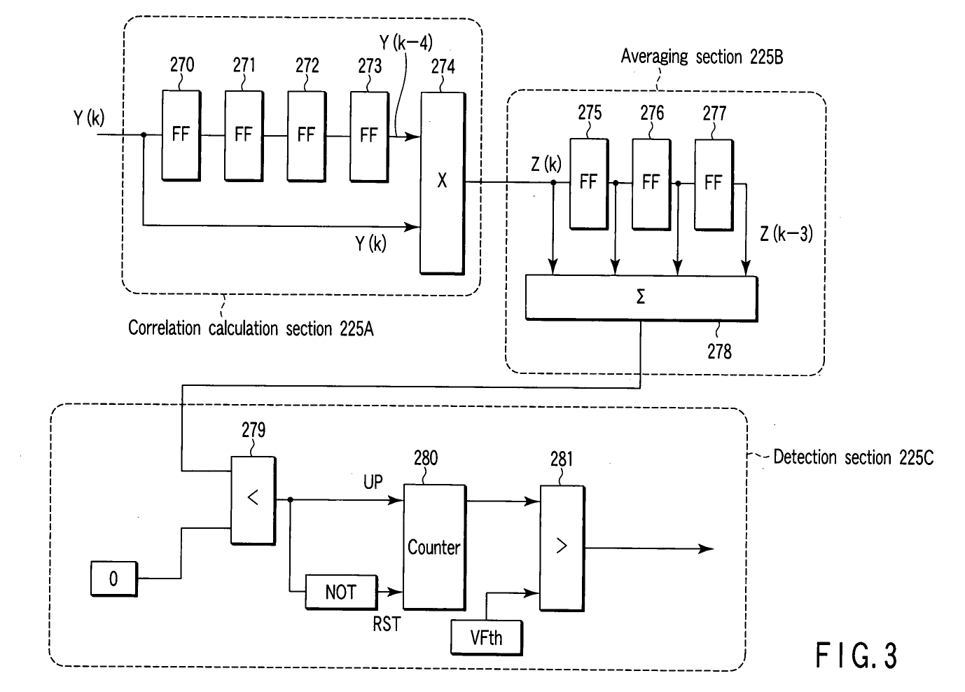

The VFO area detection section 220-5 will be described referring to FIG. 3.

The VFO area detection section 220-5 includes a correlation calculation section 220-5A, an averaging section 220-5B, and a detection section 220-5C. The correlation calculation section 220-5A calculates an autocorrelation of the input signal to detect a certain periodic pattern peculiar to a VFO area.

Specifically, the input signal is set to be Y(k), and it is delayed by one time in each of flip-flops 270, 271, 272, 273 to which the input signal is serially connected. Then, the output of the flip-flop 273 will be Y(k−4) which is delayed four times from the input signal Y(k).

A multiplication circuit 274 operates Y(k)×Y(k−4). As described above, a signal whose cycle is fixedly 8-channel clock is recorded in the VFO area. Thus, for the signal in the VFO area, the autocorrelations distant by four times are exactly in a reverse phase relation, and a negative correlation will be maximized. Even if an oscillation frequency of a voltage control oscillator in a PLL circuit which generates the sampling clock is slightly deviated from a channel clock frequency of the reproduction signal, the autocorrelations distant by four times indicate a strong negative correlation in the VFO area. However, as an actual reproduction signal contains various noise components, it is averaged in an averaging section 115B to remove the noise.

In an example of FIG. 3, a sum of values of Z(k) of sequential four samples, that is,
Z(k)+Z(k−1)+Z(k−2)+Z(k−3)
is obtained, wherein Z(k) is an output of the correlation calculation section. Proper values may be set for the four samples in this summation zone in accordance with the signal-to-noise ratio of the actual reproduction signal, and equivalent effects can also be provided for 6 samples and 8 samples. The output value of the averaging section 220-5B is evaluated regarding strength of the negative correlation in the detection section 220-5C.

The output of the averaging section 220-5B is input to a level setting section 279 of the detection section 220-5C. An output of this level setting section 279 is input to a counter 280. The counter 280 is incremented one by one when the input is “1”, and an output thereof is reset to 0 when the input is “0”. That is, the counter 280 is incremented when the output value of the averaging section 220-5B is negative, and the counter 280 is reset to 0 when the output value of the averaging section 220-5B is positive.

The output of the counter 280 is compared with a predetermined threshold value (VFth) in a comparison section 281, and a VFO area detection output will be “1” when the value of the counter 280 is greater than the threshold value (VFth).

In such a configuration, after the start of reproduction in the VFO area, the VFO area detection output will be “1” after about “VFth+α” bits, and the VFO area detection output will be “0” substantially simultaneously with the end of the VFO area. In this manner, it is possible to detect arrival of the VFO area even in an asynchronous state.

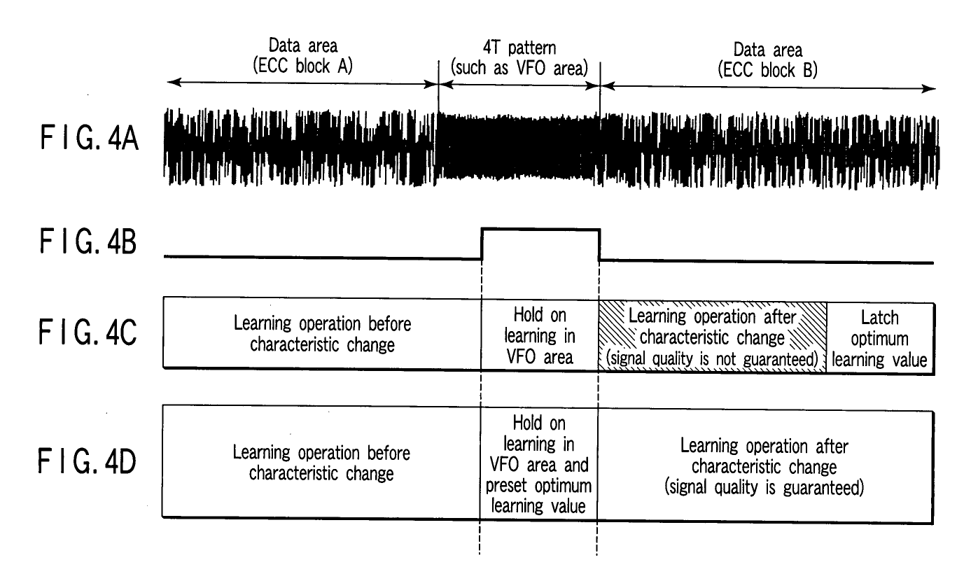

FIGS. 4A to 4D show timing and a sequence when the circuits as described above operate. Such timing and sequence allow compensation of the level difference in signal characteristics. FIG. 4A shows the output of the waveform pre-equalizer 103 or the output of the analog-to-digital converter 214. FIG. 4B shows a detection signal when the VFO area detection section 220-5 detects the VFO area. FIG. 4C shows a sequence during pre-learning implemented in pre-reproduction. FIG. 4D shows a sequence during normal reproduction reflecting the optimum equalization coefficient learned in the pre-learning.

FIGS. 4A to 4D show a case where the signal characteristic in a data area varies before and after the VFO (between a data area (ECC block A) and a data area (ECC block B)).

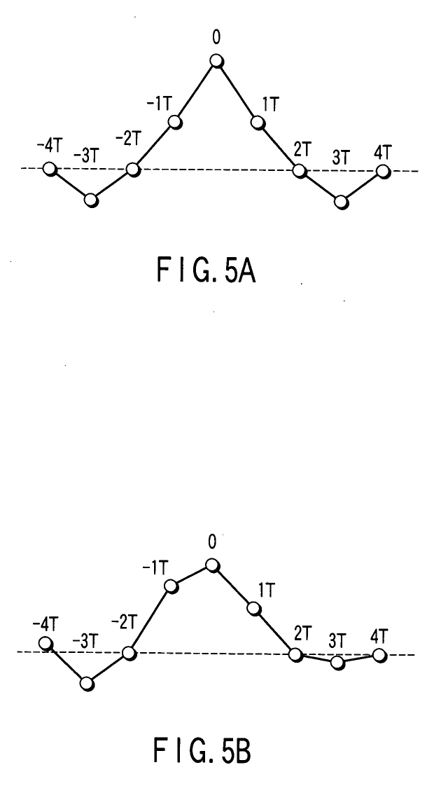

For example, in the ECC block A area, an adaptive equalization coefficient shown in FIG. 5A is regarded as an optimum coefficient value, and in the ECC block B area, an adaptive equalization coefficient shown in FIG. 5B is similarly regarded as an optimum coefficient value.

First, the ECC block A and the ECC block B are reproduced in advance (however, if the ECC block A has already been pre-learned, the ECC block B may only be reproduced). By reproducing a few sectors, the adaptive equalizer 215 makes progress in learning, thereby making it possible to obtain coefficients in FIG. 5A and FIG. 5B which are the optimum coefficient values. This value is stored in the optimum equalization coefficient storage section 220-3. In this pre-reproduction processing, it is not necessary to operate the circuit subsequent to the synchronous demodulator 217. Further, an initial equalization coefficient preset in the adaptive equalizer 215 may be a proper value which is not far away from the optimum values.

Next, as an actual reproduction operation, seeking is performed to move to a portion immediately before the ECC block A, and normal reproduction processing is started. When the VFO area located before the ECC block A is detected, the optimum coefficient value (FIG. 5A) suitable for the ECC block A is preset to the adaptive equalizer 215. By reproducing the ECC block A in this state, the reproduction operation with a small equalization error can be achieved.

When reproduction is completed up to the ECC block A, reproduction of a 4T-pattern area (such as the VFO area) which is not a data area is then started. Here, after the VFO area detection section 220-5 issues a VFO area detection signal after a certain delay.

The adaptive equalizer 215 holds the adaptive learning together with a rising edge of this signal, and draws the optimum coefficient value in the ECC block B area from the optimum equalization coefficient storage section 220-3, and then the optimum coefficient value is preset to the adaptive equalizer 215.

Finally, a falling edge of the VFO area detection signal causes data reproduction in the ECC block B to be started, at which moment the holding of the adaptive learning is cancelled, and the learning is caused to follow this with a low gain. That is, at the start of reproduction of the ECC block B, a pre-learned coefficient is set, after which a sequential learning state is brought about. This is implemented to sequentially obtain adaptive coefficients. For the next VFO area detection signal, a pre-learned coefficient for a next ECC block V is set.

A period of pre-learning can be set as an interrupt processing period while data in the ECC block is subjected to error correction processing via a buffer circuit follows by decoding processing.

By processing the reproduction signal at times as described above, both the ECC block A and the ECC block B can be stably reproduced without becoming unable to make corrections even when the signal characteristic greatly varies before and after the VFO area.

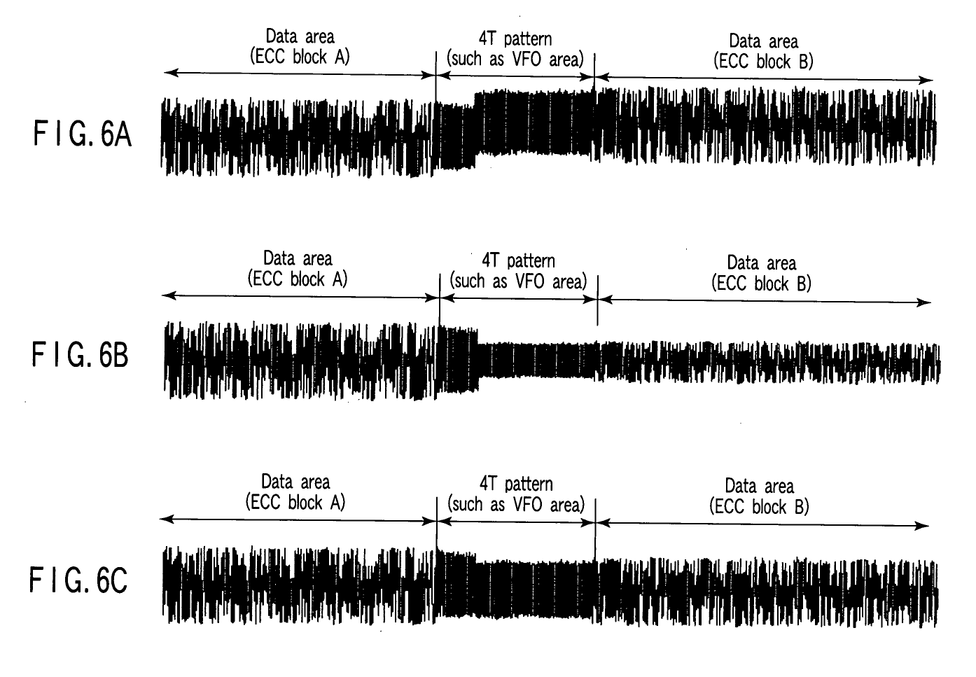

It is to be noted that various times for the pre-learning in the pre-reproduction are possible. For example, learning can be performed while the normally reproduced signal is decoded. This concept can be applied not only to the adaptive equalizer 215 but also to other control circuits, and it can also be applied to, for example, the offset control section 211, the asymmetry control section 212 and the amplitude control section 213 shown in the block diagram of the present embodiment. Further, when the signal characteristic varies as shown in FIGS. 6A to 6C, a pre-learning result is reflected in the control sections having the respective characteristics to compensate for the signal characteristic.

FIG. 6A shows a radio-frequency signal when offset amounts are different between the ECC block A and the ECC block B, and FIG. 6B shows a radio frequency signal when amplitude values are different between the ECC block A and the ECC block B. FIG. 6C shows a radio-frequency signal when asymmetry amounts are different between the ECC block A and the ECC block B.

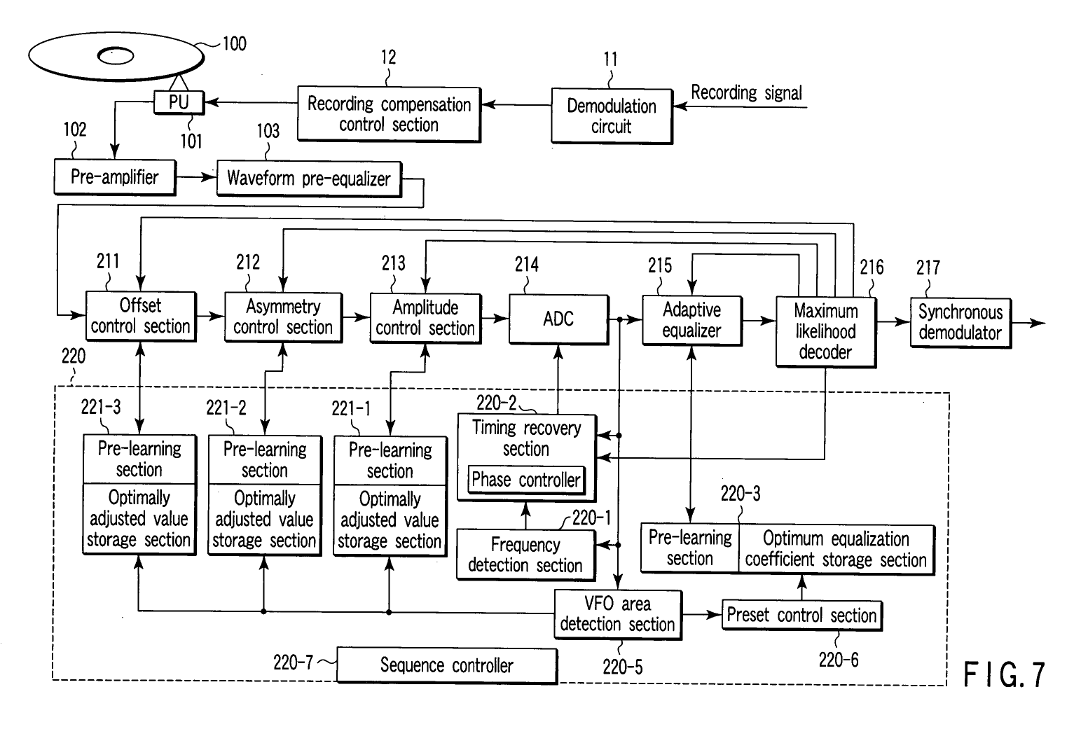

FIG. 7 shows one example in another embodiment of the optical disk apparatus of this invention.

The disk apparatus in FIG. 7 is different from the disk apparatus in FIG. 1 in that the disk apparatus in FIG. 7 further comprises pre-learning sections and optimally adjusted value storage sections 221-1, 221-2, 221-3. Other parts are the same as those in the apparatus in FIG. 1.

The pre-learning section and optimally adjusted value storage section 221-1 pre-learn the signal characteristic change (amplitude change) as shown in FIG. 6B, and provide an amplitude adjusted value to the amplitude control section 213 during the VFO area detection. The pre-learning section and optimally adjusted value storage section 221-2 pre-learn the signal characteristic change (change in asymmetry amount) as shown in FIG. 6C, and provide an asymmetry adjusted value to the amplitude control section 213 during the VFO area detection. The pre-learning section and optimally adjusted value storage section 221-3 pre-learn the signal characteristic change (change in offset amount) as shown in FIG. 6A, and provide an offset adjusted value to the offset control section 211 during the VFO area detection.

This invention is not limited to the embodiments described above. It is impossible in some cases to recognize on the apparatus side at which break point of the ECC block the level difference in signal characteristics attributed to a difference of recording drives is caused. Thus, if the above-mentioned concept is considered in terms of more practical operation, the value in FIG. 5A which is the optimum equalization coefficient in the ECC block A area is continuously used to try to reproduce the ECC block B area. Here, the optimum equalization coefficient (coefficient value learned during reproduction) after the reproduction of the ECC block B area is stored in the optimum equalization coefficient storage section only when corrections can not be made in a subsequent correction circuit, and if it is reproduced in the above-mentioned switch sequence during rereading processing, the pre-learning is not needed and efficient reproduction processing can be performed.

This invention is not limited to the embodiments described above. There is a method of using, as means for detecting the break points of the ECC block, address information included in wobbles.

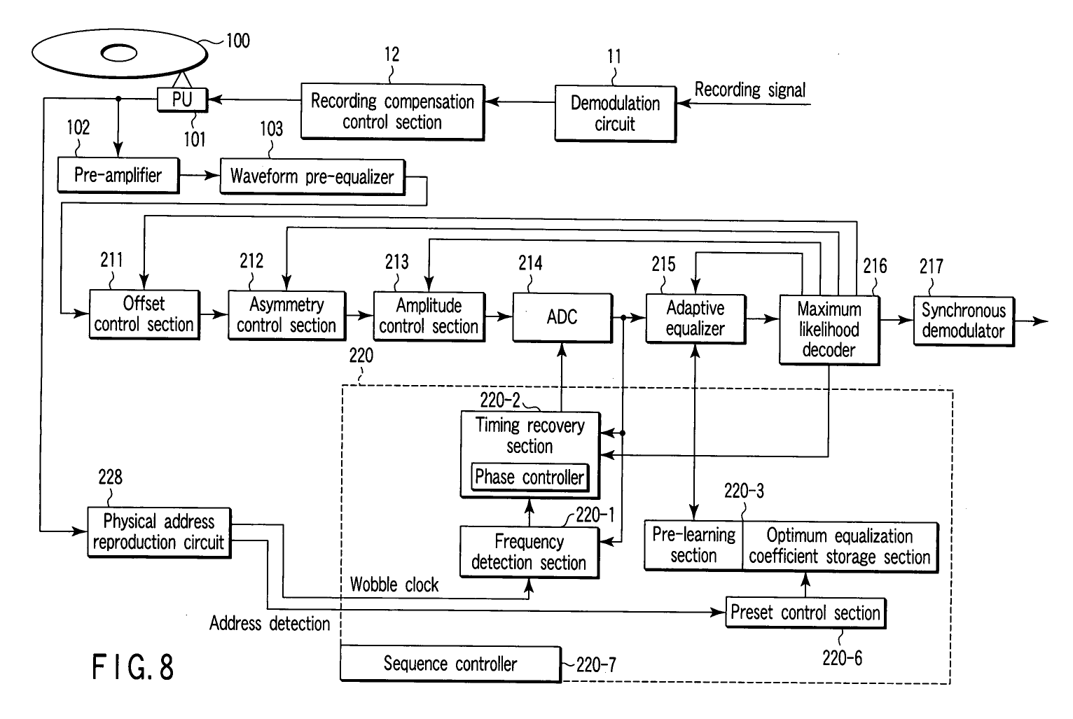

FIG. 8 shows still another embodiment of the optical disk apparatus shown in FIG. 1 and FIG. 7. The optical disk apparatus in FIG. 8 is different from-the disk apparatuses in FIG. 1 and FIG. 7 in that a physical address reproduction circuit 228 is provided using the wobbles of a track. This physical address reproduction circuit 228 is used in place of the above VFO area detection section 220-5.

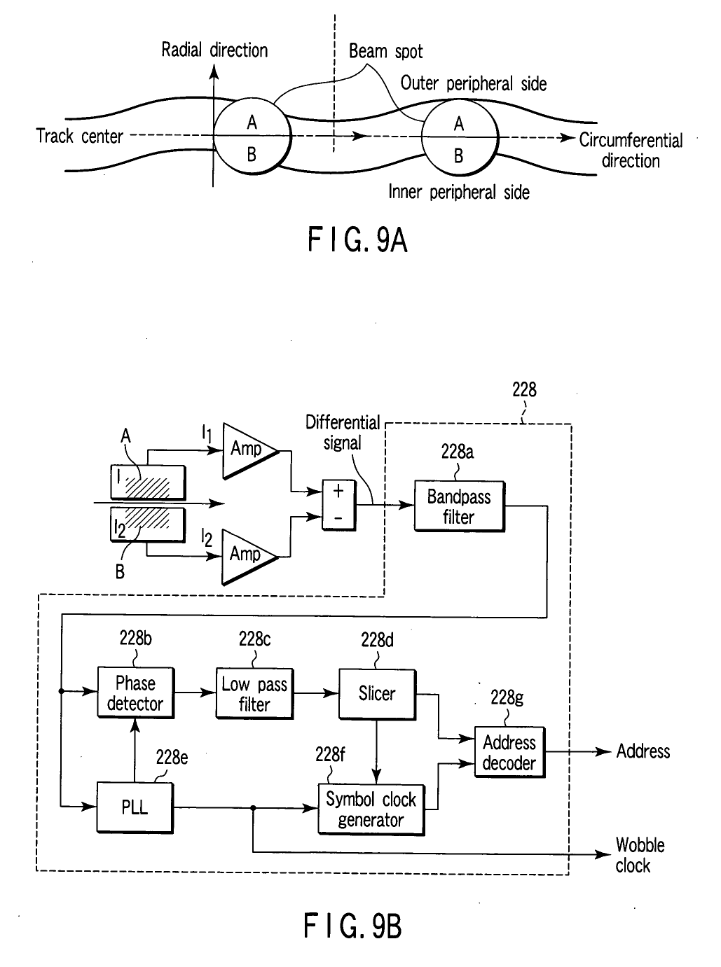

FIG. 9A shows a relation between the track of the recording medium and a laser beam spot, and FIG. 9B shows the physical address reproduction circuit 228.

The optical pickup 101 detects light reflected from the optical disk medium by laser light irradiation to output two kinds of signals: a differential signal including the address information and a sum signal including data information. FIG. 9B shows a system of the differential signal. A recording track in a rewritable information recording medium slightly wobbles in a radial direction. The reflected light is detected by a sensor of an optical head, but the optical sensor is divided in the radial direction as shown in FIG. 9B. On the sum signal side of signals detected by the respective sensors, a signal corresponding to a crystal condition of the optical disk medium is obtained because a signal level conforms to a track width in the beam spot, whereas a signal corresponding to the wobbles of the track is obtained for the differential signal.

FIG. 9B shows the physical address reproduction circuit 228 to obtain the address information from the phase-modulated differential signal (wobble signal). The wobble signal contains noise intrinsic to the medium, noise due to crosstalk from adjacent tracks, etc. It is thus necessary to remove the noise out of a frequency band of the wobble signal via a band pass filter (BPF) 228a or the like.

The wobble signal from which the noise has been removed is input to a phase detector 228b and a phase-locked loop circuit (PLL) 228e to generate a carrier.

In the PLL 228e, a carrier synchronous with the wobble signal is output by phase synchronization processing. In the phase detector 228b, phase detection processing <<phase detection>> is implemented using the wobble signal and the carrier. This is because the wobble signal has been modulated by phase inversion of the carrier with “0” and “1”.

A representative method for the phase detection processing is to judge polarity of a phase by multiplication of a modulated signal and the carrier to obtain “0” and “1”. A waveform after the multiplication is detected in a form offset by a first phase and a second phase. Subsequently, a radio-frequency (frequency twice as high as that of an original waveform) generated by the phase detection is removed using a low pass filter (LPF) 228c or the like. Then, threshold detection is performed for a waveform after the LPF by a slicer 228d to binarize the signal.

A clock (hereinafter called a symbol clock) synchronous with an address bit is required to obtain bit information of an address from the binarized waveform. The symbol clock is generated using a wobble clock synchronous with a wobble cycle output from the PLL 228e and the binarized signal output from the slicer 228d.

A symbol clock generator 228f processes the binarized signal so that a waveform resulting from 1/N dividing of the wobble clock is synchronized. Here, N is decided by a wobble wave number used to express one address bit. For example, when one address bit comprises four wobble waves, polarity is switched in the binarized signal by the wobble wave number which is multiple of 4. A shortest modulation cycle in this case is four wobbles. Therefore, in this example, if N is 4, a clock synchronous with the address bit can be generated.

The 1/N-divided wobble clock synchronous with the binarized signal is sent as the symbol clock to an address decoder 228g. The address decoder 228g decodes the address using the binarized signal input from the slicer 228d and the symbol clock <<the address decoding is executed>>.

The wobbles are generally modulated to include the synchronization signal indicating a start position of the address information in addition to physical address information. The synchronization signal is often modulated with a modulation cycle different from that of the address bit to prevent from being erroneously identified as the address information. In this case, it is necessary to generate the symbol clock with the minimum modulation cycle including the synchronization signal. However, when the synchronization signal is detected in a manner different from that for address bit detection (e.g., detection in one wobble wave unit), the symbol clock may be adjusted to the shortest modulation cycle of the address bit.

In this way, it is possible to obtain the address information from the modulated wobble signal. Further, it is obvious that since there exists a positional (temporal) relation described later between the differential signal and the sum signal, data in the next ECC block starts after 24 wobble cycles from a final point of a seventh wobble segment of each ECC block.

Thus, it is possible to know a breakpoint of the ECC block by obtaining the address information from the wobble signal. In other words, when different optical disk apparatuses are used to write in the precedent and subsequent ECC blocks, this means that the signal characteristic changes in this area.

If such an address reproduction circuit 228 is provided, it is possible to know the arrival of the VFO without fail. For example, a VFO area detection circuit shown in FIG. 3 is small in size and enables detection in a simple manner, but it might be affected by a phase lag of the VFO, a decrease in length of the VFO area due to an overwrite operation and a random shift and the like, a frequency error, whereas the address reproduction circuit 228 is free of such concern.

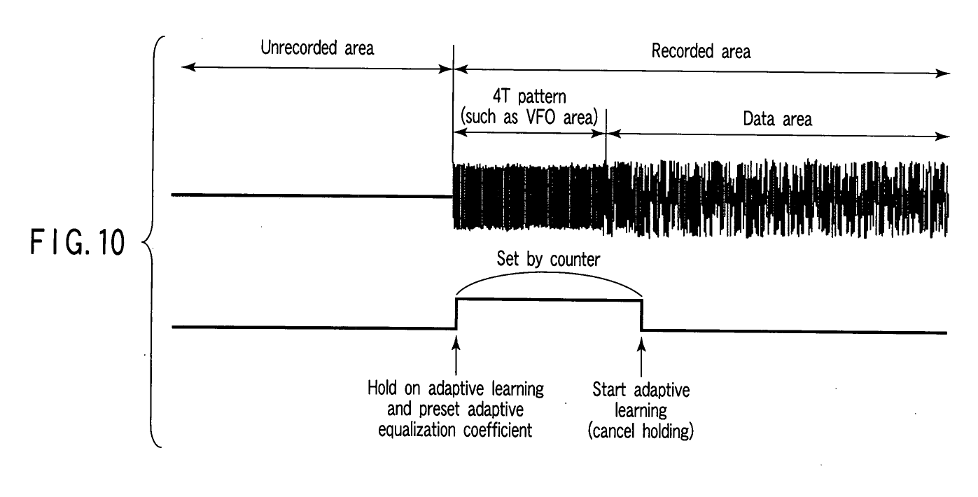

Furthermore, in switching from an unrecorded area to a recorded area as shown in FIG. 10, the address can also be reproduced in the unrecorded area, and a start of the ECC block which is the recording area can be easily detected by the address reproduction circuit 228. However, random shift control is performed in writing, and thus an end of the VFO area cannot be completely recognized, so that the learning of the adaptive equalizer is started after protection has been provided by the counter to a point which is absolutely located in the data area.

Next, a data structure in the optical disk applied to the present invention will be described.

FIG. 11 shows one example of a form of a data frame to be recorded on the optical disk according to the present invention. The data frame has 2064 bytes comprising 172 bytes×2×6 rows, in which 2048-byte main data is contained. This data frame is processed in a manner divided into a left group and a right group.

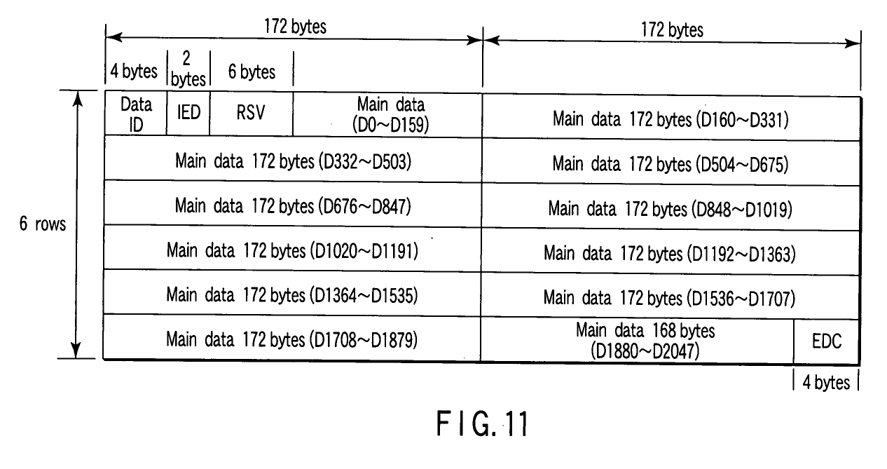

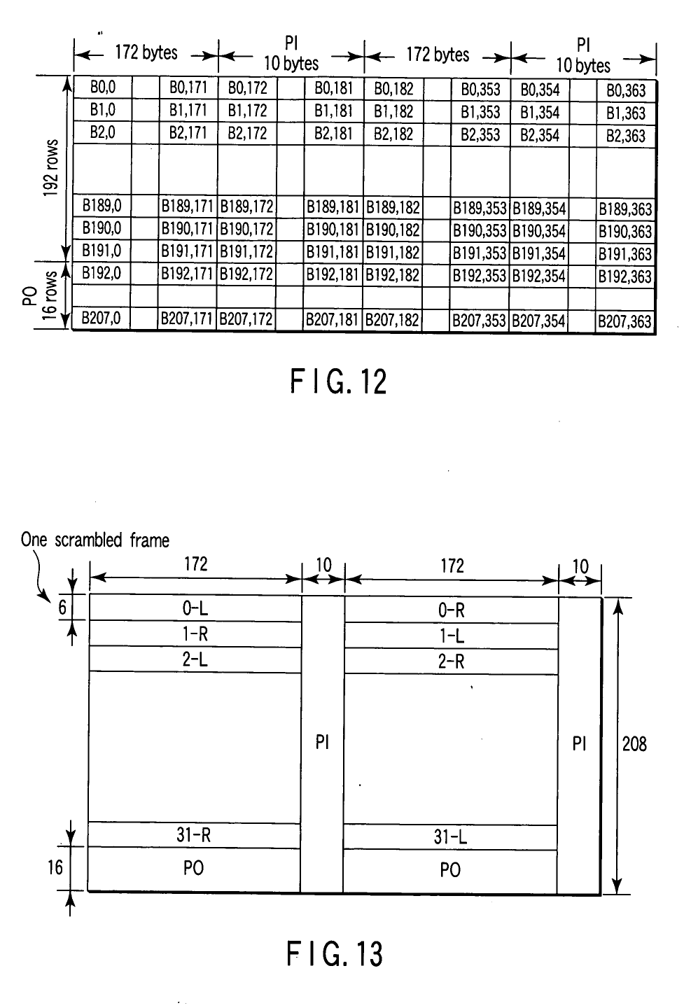

Such 32 data frames are gathered and vertically arranged, and error correction codes for a parity out (PO) sequence and a parity in (PI) sequence are further added thereto, thereby forming an error correction code (ECC) block in FIG. 12.

In this case, 32 sectors are gathered as shown in FIG. 13 to constitute each of small ECC blocks on the right and left (blocks on the right and left sides of the drawing). Signs such as “2-R” in FIG. 13 represents sector numbers and right/left group identification signs (e.g., second data on the right side) (L in FIG. 13 indicates left). Thus, right and left frames in the same sector are interleaved (alternately included in different groups at regular intervals), they belong to the different small ECC blocks on a group basis.

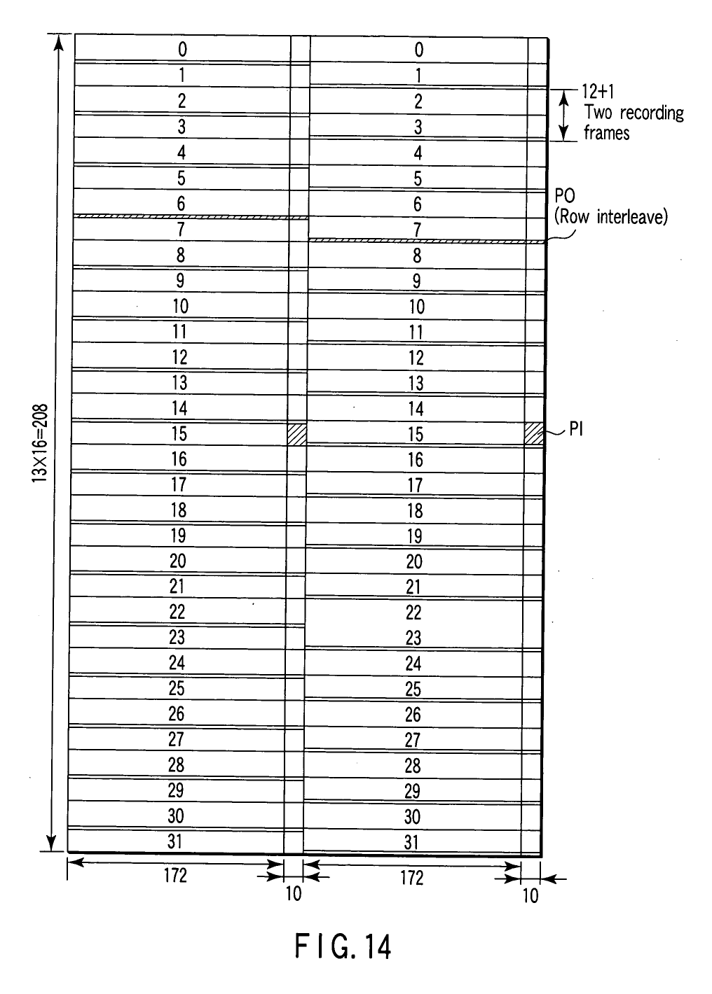

Next, as shown in FIG. 14, 16 rows of the PO sequence are dispersedly arranged. In this case, the 16 rows of the PO sequence are dispersedly arranged at a rate of one row to main data 12 rows (2 frames). However, as understood from FIG. 14, the rows of the PO sequence are arranged so that they are not located on the same row in the right and left groups. That is, this is a structure (FIG. 14) in which the data in different OP groups are alternately inserted in each sector. The structure is provided in which PO interleaving/insertion positions are different on the right and left.

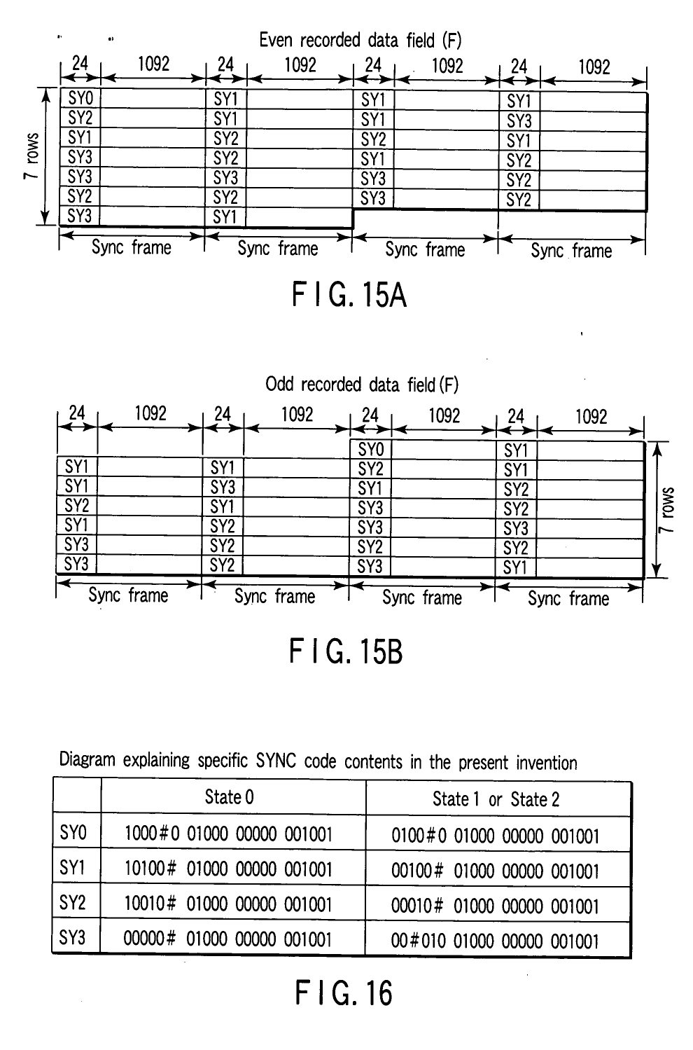

Here, FIGS. 15A and 15B show the synchronization signal added to some of the data in FIG. 14. As shown in FIGS. 15A and 15B, a synchronous frame structure is varied as shown in FIGS. 15A and 15B depending on whether sector numbers of the sectors constituting one ECC block are even or odd. FIG. 15A shows an even data field, and FIG. 15B shows an odd data field.

Referring to FIG. 16, specific SYNC code contents are explained. A modulation regulation in the present embodiment has three states including state 0 to State 2. For example, four kinds of SYNC codes including SY0 to SY3 are set, and selected from the right and left groups in FIG. 16 depending upon the state. In a current DVD standard, RLL (2, 10) (run-length limited: d=2, K=10; a minimum value is 2 and a maximum value is 10 in a range where 0s continue) in 8/16 modulation (8 bits are connected to 16 channel bits) is employed as a modulation method, and four states from State 1 to state 4 and a eight kinds of SYNC codes from SY0 to SY7 are set for modulation.

By comparison, the kinds of SYNC codes are reduced in the present embodiment. In an information recording/reproduction apparatus or an information reproduction apparatus, the kind of SYNC code is identified by a pattern matching method during information reproduction from the recording medium. The kinds of SYNC codes are significantly reduced as in the present embodiment, so that target patterns are reduced which are needed in matching for SYNC code detection, and processing needed for pattern matching is simplified to improve processing efficiency, and moreover, a recognition speed can be increased.

In FIG. 16, bits (channel bits) indicated by # represent digital sum value (DSV) control bits. The DSV control bit is determined by a DSV controller to suppress DC components (to approximate a DSV value to “0”) as described later. That is, “1” or “0” is selected as a value of “#” so that, in broad perspective, the DSV value approximates to “0” including frame data areas (1092-channel bit area in FIG. 15A or 15B) on both sides of the SYNC code.

Referring to FIG. 16, the SYNC code in the present embodiment is explained.

(1) Synchronous Position Detection Code Section:

This section has a pattern common to all the SYNC codes, and forms a fixed code area. By detecting this code, locations of the SYNC codes can be detected. Specifically, this signifies a portion corresponding to last 18 channel bits in each SYNC code of FIG. 16 “010000 000000 001001”.

(2) Conversion Table Selction Code Section During Conversion:

This is a code which forms part of a variable code area and changes in accordance with a state number during modulation. A first one channel bit portion in FIG. 16 corresponds thereto. That is, when one of State 1 or State 2 is selected, the first one channel bit is “0” in any one of codes in SY0 to SY3, and when state 0 is selected, the first one channel bit in the SYNC code is “1”. However, exceptionally, the first one channel bit of SY3 in state 0 is “0”.

(3) SYNC Frame Position Identification Code Selction:

The codes to identify the kinds including SY0 to SY3 in the SYNC code constitute part of the variable code area. First to sixth channel bit portions in each SYNC code in FIG. 16 correspond thereto. A relative position in the same sector can be detected from combined patterns of three SYNC codes sequentially detected as described later.

(4) DC Suppression Polarity Reversal Code Selction:

A channel bit at the position “#” in FIG. 16 corresponds to this, and as described above, the bit here is reversed or not reversed, thereby serving to cause the DSV value in a channel bit row including precedent or subsequent frame data to approximate to “0”.

In the present embodiment, 8/12 modulation (ETM: eight-to-twelve modulation) and RLL (1, 10) are employed as the modulation method. That is, 8 bits are converted to 12-channel bit during modulation, and a range after conversion in which 0s continue is set so that a minimum value (d value) will be 1 and a maximum value (k value) will be 10. In this case, d=1 enables higher density than before, but a reproduction signal amplitude decreases at a densest mark.

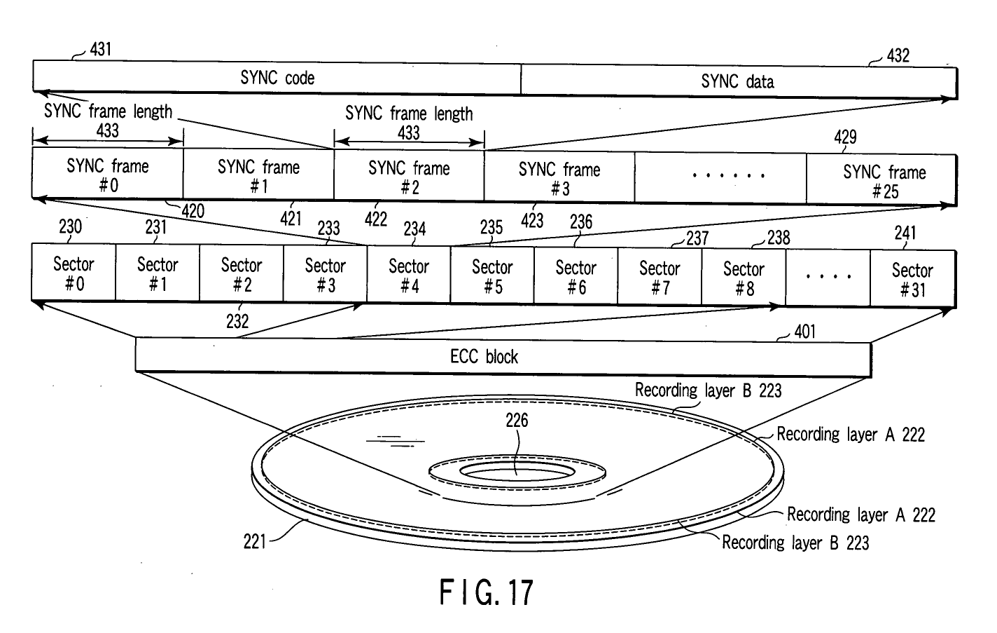

Next, a relation between the optical disk and the data to be recorded on the optical disk will be described. As shown in FIG. 17, in the present embodiment, the data to be recorded on a recording medium 221 has a hierarchical structure of recorded data as shown in FIG. 17, regardless of the kind of recording medium 221 (reproduction only/incremental-writable type/rewritable type).

That is, one ECC block 401 which is a greatest data unit that enables data error detection or data error correction includes 32 sectors 230 to 241. Details of each ECC block 401 are shown in FIG. 14.

The sectors 230 to 241 shown in FIG. 17 have the same contents as those of the sectors 231 to 238 to be recorded in pack units shown in FIGS. 15A and 15B. As already described with FIGS. 15A and 15B and as again shown in FIG. 17, each of the sectors 230 to 241 includes 26 SYNC frames (#0) 420 to (#25) 429. One SYNC frame includes a SYNC code 431 and SYNC data 432 as shown in FIG. 17. One SYNC frame includes data having 1116 (=24+1092) channel bits as shown in FIGS. 15A and 15B. A SYNC frame length 433 which is a physical distance on the recording medium 221 where one SYNC frame is recorded is substantially fixed (when a change in physical distance for synchronization within a zone is excluded) in many cases.

Data structure in a second example of reproduction-only recording medium.

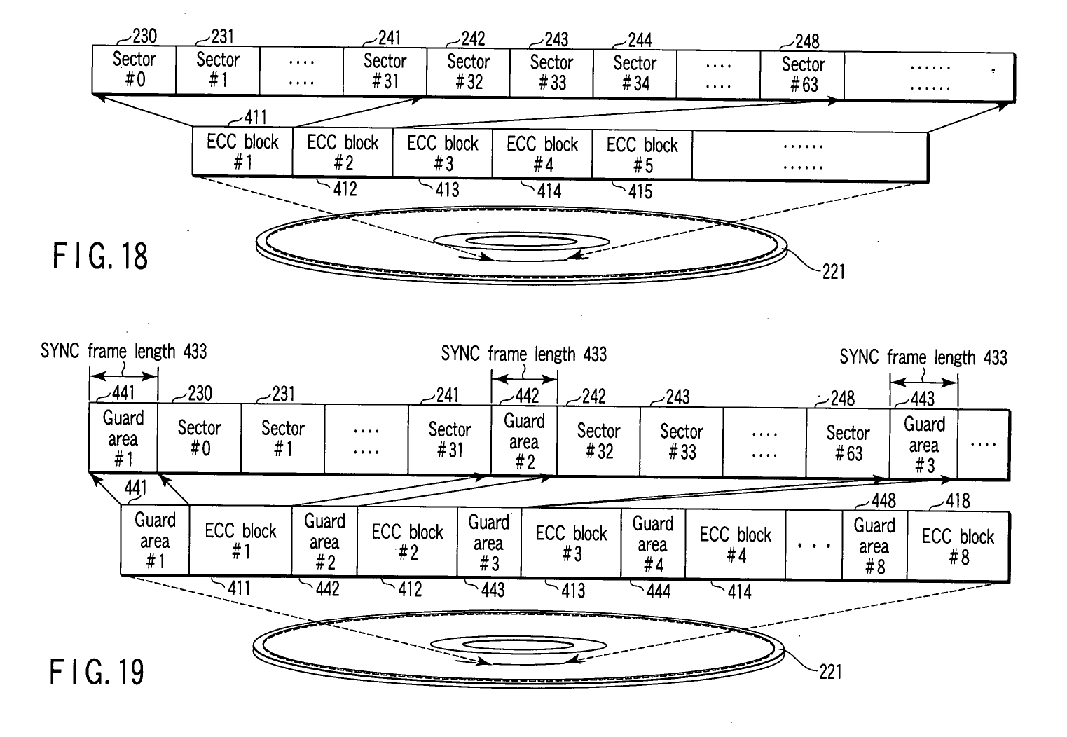

A plurality of kinds of recording formats can be set in a reproduction-only recording medium. Specifically, there are two kinds of recording formats shown in a first example (FIG. 18) and a second example (FIG. 19) for the reproduction-only recording medium. In the example shown in FIG. 18, in ECC blocks (#1) 411 to (#5) 415, recording is sequentially performed on the recording medium 221 in a physically stuffed state. Conversely, in the example shown in FIG. 19, guard areas (#1) 411 to (#8) 448 are inserted in ECC blocks (#1) 411 to (#5) 418. A physical length of the guard areas (#1) 411 to (#8) 448 corresponds to the SYNC frame length 433.

As already described with FIGS. 15A and 15B, for a physical length of the data to be recorded on the recording medium 221, the SYNC frame length 433 is treated as a basic unit. Thus, the physical length of the guard areas (#1) 411 to (#8) 448 is adapted to correspond to the SYNC frame length 433, thereby making it easy to manage a physical arrangement of the data to be recorded on the recording medium 221 and to control access to the data.

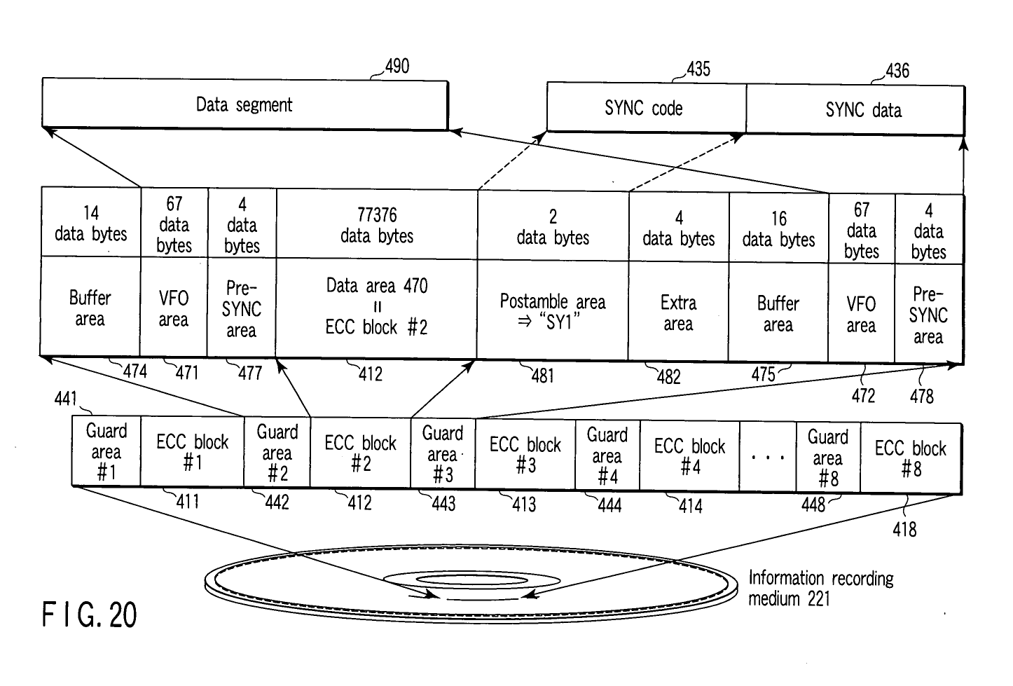

FIG. 20 shows detailed structure in the guard area in the second example shown in FIG. 19. While the structure in the sector comprises a combination of the SYNC code 431 and the SYNC data 432 as shown in FIG. 17, the SYNC code 435 and a SYNC data 436 are similarly combined in the guard area. Modulated data is also arranged in the SYNC data 436 area in the guard area (#3) 443 in accordance with the same modulation regulation as that for the SYNC data 432 in the sector.

Areas in one ECC block 401 shown in FIG. 17 and in one ECC block (#2) 412 comprising 32 sectors shown in FIG. 20 are called the data areas in the present embodiment.

Variable frequency oscillator (VFO) areas 471, 472 shown in FIG. 20 are used to synchronize the information reproduction apparatus or the information recording/reproduction apparatus with a reference clock when the data area is reproduced. Regarding data contents to be recorded in VFO(s) 471, 472, data before modulation in a common modulation regulation described later is a sequential repetition of “7Eh”, and an actually recorded channel bit pattern after modulation is a repeated pattern of “010001 000100” (pattern in which three sequential 0s are repeated). It is to be noted that, to be able to obtain this pattern, State 2 in the modulation needs to be set in a front byte of the VFO areas 471, 472.

A pre-SYNC area 477, 478 represents a boundary position between the VFO area 471, 472 and a data area 470, and a recorded channel bit pattern after modulation is a repetition of “100000 100000” (pattern in which five sequential 0s are repeated).

In the information reproduction apparatus or the information recording/reproduction apparatus, a pattern change position of the repetitive pattern of “100000 100000” in the pre-SYNC area 477, 478 is detected from a repetitive pattern of “010001 000100” in the VFO area 471, 472, thereby recognizing that the data area 470 is approaching.

A postamble area 481 indicates an end position of the data area 470, and also represents a start position of a guard area 443. A pattern in the postamble area 481 corresponds to a pattern of SY1 in the SYNC code.

An extra area 482 is an area used for copy control and illegal copy prevention. In particular, when the extra area 482 is “not used” for the copy control and illegal copy prevention, it is totally filled with 0s by the channel bit.

In a buffer area, “7Eh” is sequentially repeated before modulation in the same manner as in the VFO area 471, 472, and an actually recorded channel bit pattern after modulation is a repeated pattern of “010001 000100” (pattern in which three sequential 0s are repeated). It is to be noted that, to be able to obtain this pattern, State 2 in the modulation needs to be set in the front byte of the VFO areas 471, 472.

As shown in FIG. 20, the postamble area 481 in which the pattern of SY1 is recorded corresponds to the SYNC code area 435, and an area from the extra area 482 immediately after the postamble area 481 to the pre-SYNC area 478 corresponds to the SYNC data area 434. Further, an area ranging from the VFO area 471 to a buffer area 475 (i.e., an area including the data area 470 and part of the guard area before and after the data area 470) is called a data segment 490 in the present embodiment, which shows a content different from that of a physical segment described later. Moreover, sizes of the data shown in FIG. 20 are expressed in the number of bytes of data before modulation.

Method of utilizing the extra area in the second example of reproduction-only recording medium FIG. 20 shows an example of an arrangement structure in which recorded data blocks including the guard area are data segments. On a front side, the VFO area 471 is disposed so that a channel bit reading clock generation PLL for demodulation of modulated recording signals is easily phase-locked. A subsequent stage comprises the postamble area 481 for the synchronization signal in the guard area, the extra area 482 used for protection of the data area, a control signal and the like, and the buffer area 475 which can easily be connected to the VFO area disposed in the front-side guard area in the data segment to be connected.

However, in recording processing on recording type media, a 93-byte frame length is not always ensured for the guard area due to various factors such as random shift writing used at the start of recording the data segment and also used to start writing in a manner to shift a recording start position back and forth for protection of a recording film, and displacement in recording in incremental recording.

In recording the data segments 490 as described above, since data in the extra area 482 is not data protected by the data area, the extra area 482 is not managed from the outside, and can therefore be used as confidential information recording/reproduction area to store main data in the data area such as content copyright protection control signal for images, sounds, etc. However, because this area is disposed in a small range of guard areas, it is difficult to protect from data error occurrence due to defects or the like, so that in the present embodiment, data in the extra area are gathered which are arranged in a plurality of data segments specified by the number (ECC block number) of the data segment, and used for copyright protection confidential information.

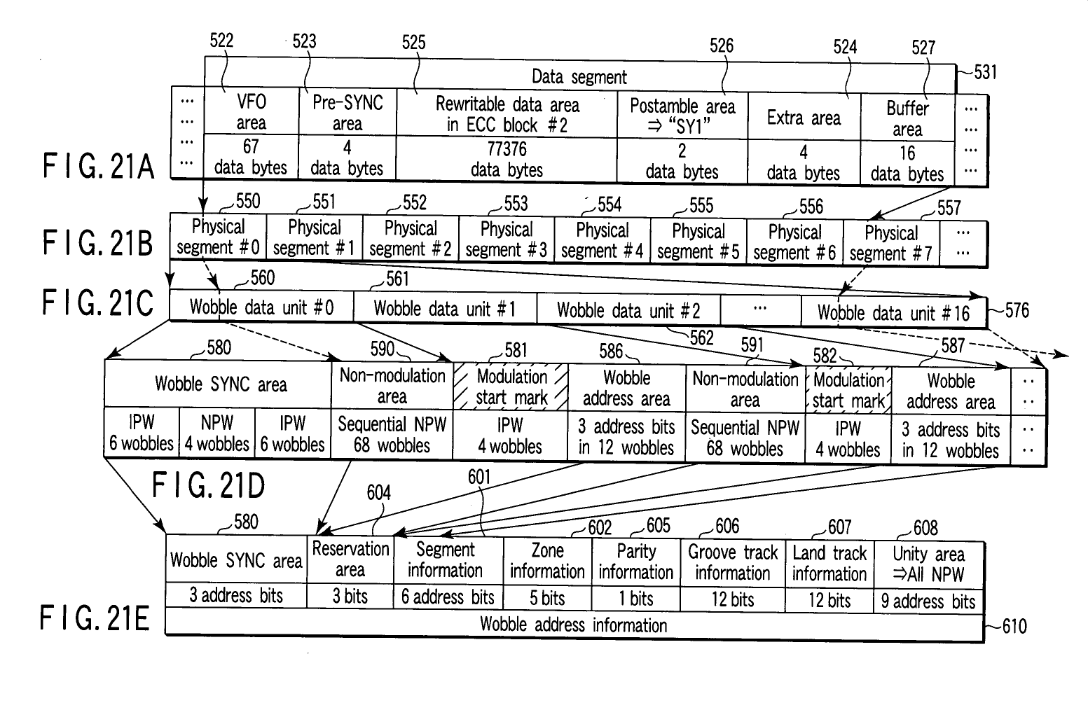

Next, the recording format for the address information using wobble modulation in the recordable recording medium will be described using FIGS. 21A to 21E. An address information setting method using the wobble modulation is characterized in that addresses are allocated using the SYNC frame length as a unit. One sector includes 26 SYNC frames, and one ECC block includes 32 sectors. Therefore, one ECC block includes 26×32=832 SYNC frames.

Since a length of each guard area located between the ECC blocks corresponds to one SYNC frame length, a length in which one guard area and one ECC block 411 are added comprises 832+1=833 SYNC frames. Here, this can be factorized into prime factors:
833=7×17×7 (101)
and a structure is therefore provided to take advantage of this characteristic.

That is, as shown in FIGS. 21A and 21B, an area equal to a length of an area in which one guard area and one ECC block are added is defined as a data segment 531 which is a basic unit of rewritable data (a structure within the data segment in the rewritable recording medium and incremental-writable recording medium corresponds to a data structure segment in the reproduction-only recording medium. Further, an area having the same length as a physical length of one data segment 531 is divided into seven physical segments (#0) 550 to (#6) 556, and wobble address information 610 (FIG. 21E) is recorded in advance in each of the physical segments (#0) 550 to (#6) 556 in a form of wobble modulation.

As shown in FIG. 21A, a boundary position of the data segment 531 and a boundary position of the physical segment 550 do not coincide and are displaced in an amount described later. Further, 17 wobble data units (WDU) (#0) 560 to (#16) 576 are allocated to the physical segments (#0) 550 to (#6) 556, respectively (FIG. 21C).

It is understood from Equation (101) that 7 SYNC frames are allocated to a length of one wobble data unit (#0) 560 to (#16) 576. Each of the wobble data units (#0) 560 to (#16) 576 includes a modulation area corresponding to 16 wobbles and a non-modulation area corresponding to 68 wobbles. The wobble data unit (#0) includes a modulation area 580 corresponding to 16 wobbles and a non-modulation area 590 corresponding to 68 wobbles.

The present embodiment is characterized in that an occupancy ratio of the non-modulation area 590 or a non-modulation area 591 to the modulation area has been increased.

Since a groove or a land always wobbles at constant frequency in the non-modulation area 590, 591, the PLL is exerted using the non-modulation area 590, 591, thereby making it possible to stably extract (generate) the reference clock for reproduction of a recording mark recorded on the recording medium or a recording reference clock used for new recording.

For a shift from the non-modulation area 590, 591 to the modulation area, a modulation start mark 581, 582 is set using four wobbles to provide a data structure in which a wobble-modulated wobble address area 586, 587 appears (arrives) immediately after the modulation start mark 581, 582. To actually extract the wobble address information 610, the non-modulation area 590, 591 in each of the wobble segments (#0) 550 to (#6) 556, the wobble SYNC area 580 from which the modulation start mark 581, 582 is eliminated, and the wobble address area 586, 587 are gathered as shown in FIGS. 21D and 21E to provide a rearrangement as shown in FIG. 21E.

In the present embodiment, 180-degree phase modulation and a non-return-to-zero (NRZ) method are employed as a method of representing bits of data, so that “0” or “1” of the address bit (address symbol) is set depending on whether a phase of the wobble is 0 degrees or 180 degrees.

As shown in FIG. 21D, 3 address bits are set over 12 wobbles in the wobble address area 586, 587. That is, sequential four wobbles constitute one address bit. As the present embodiment employs the NRZ method, no phase change is caused within sequential four wobbles in the wobble address area 586, 587. This characteristic is used to set wobble patterns in the wobble SYNC area 580 and the modulation start mark 581, 582.

That is, the wobble patterns which are not generated in the wobble address area 586, 587 are set in the wobble SYNC area 580 and the modulation start mark 581, 582, thereby making it easy to identify positions of the wobble SYNC area 580 and the modulation start mark 581, 582.

In other words, one address bit length is set to a length other than 4 wobbles at the position of the wobble SYNC area 580 in contrast to the wobble address area 586, 587 in which four wobbles indicate one address bit. Thus, an area in which a wobble bit is “1” is set to six wobbles different from 4 wobbles in the wobble SYNC area 580, and the whole modulation area (corresponding to 16 wobbles) within one wobble data unit (#0) 560 is allocated to the wobble SYNC area 580, thereby making it easier to detect a start position of the wobble address information 610 (location of the wobble SYNC area 580).

The wobble address information 610 includes the following.

1) Track Information 606, 607

There are alternately recorded groove track information 606 by which an address is determined on the groove (indefinite bits are generated on the land because the indefinite bits are not included), and track information 607 by which an address is determined on the land (indefinite bits are generated on the groove because the indefinite bits are not included), and these signify track numbers in the zone. In addition, track number information is recorded in gray codes or special track codes only in parts corresponding to the track information 606, 607.

2) Segment Information 601

This is information indicating segment numbers in the track (in one round of the recording medium 221). If the segment numbers are counted from “0” as segment address information 601, a pattern of “000000” appears in which 6 bits of “0” continue in the segment address information 601. In this case, it is difficult to detect a position of a boundary portion of an address bit area, and a bit shift is easily caused which is detected when the position of the boundary portion of the address bit area is displaced. As a result, an erroneous judgment on the wobble address information is caused due to the bit shift. To avoid this problem, the present embodiment is characterized in that the segment numbers are counted from “000001”.

3) Zone Identification Information 602

This indicates zone numbers in the recording medium 221, and a value of “n” in Zone (n) allocated to the disk is recorded in this information.

4) Parity Information 605

This is set to detect errors during reproduction from the wobble address information 610, and 17 address bits from the segment address information 601 to reservation information 604 are individually added, and “0” is set when an addition result is even, while “1” is set when it is odd.

5) Unity Area 608

The wobble data units (#0) 560 to (#16) 576 are set to include the modulation area corresponding to 16 wobbles and the non-modulation area 590, 591 corresponding to 68 wobbles, and the occupancy ratio of the non-modulation area 590, 591 to the modulation area has been increased, so that accuracy and stability are improved in the extraction (generation) of the reproduction reference clock and recording reference clock. Places including a unity area 608 shown in FIG. 21E directly correspond to the wobble data unit (#16) 576 in FIG. 21C and the preceding wobble data unit (#15) which is not shown. In the monotone information 608, all six address bits are “0”. Therefore, the modulation start mark 581, 582 is not set in the wobble data unit (#16) 576 and the unshown preceding wobble data unit (#15) which include the monotone information 608, and these units are non-modulation areas with completely uniform phase.

The data structure shown in FIG. 21A will be described below in greater detail.

The data segment 531 includes a data area 525 in which 77376-byte data can be recorded.

A length of the data segment 531 is generally 77496 bytes, and the data segment 531 comprises a 67-byte VFO area 522, a 4-byte pre-SYNC area 523, the 77376-byte data area 525, a 2-byte postamble area 526, a 4-byte extra area (reservation area) 524 and a 16-byte buffer area field 527.

Data in the VFO area 522 is set to “7Eh”. For a modulation state, State 2 is set in a first byte in the VFO area 522. A modulation pattern in the VFO area 522 is a repetition of the following pattern.

“010001 000100”

The SYNC code SY1 is used to record in the postamble area 526. The extra area 524 is reserved, in which all bits are “0b”. Data in the buffer area 527 is set to “7Eh”. A modulation state of a first byte in the buffer area 527 depends on a final byte in the reservation area. The modulation pattern in the buffer area except for the first byte is following pattern.

“010001 000100”

Data recorded in the data area 525 is called a data frame, scrambled frame, recording frame or physical sector depending on a stage of signal processing. The data frame comprises 2048-byte main data, 4-byte data ID, a 2-byte ID error detection code (IED), 6-byte reservation data, and a 4-byte error detection code (EDC). After EDC scrambled data is added to the 2048-byte main data in the data frame, the scrambled frame is formed. A cross reed-solomon error correction code is provided over 32 scrambled frames in the ECC block.

After ECC encoding, an outside sign (PO) and an inside sign (PI) area added to the recording frame, which results in the scrambled frame. The PO and PI are generated for each ECC block comprising 32 scrambled frames.

After the SYNC code is added to a front of each 91-byte recording frame, a recorded data area is formed into the recording frame by ETM processing. 32 physical sectors are recorded in one data area.

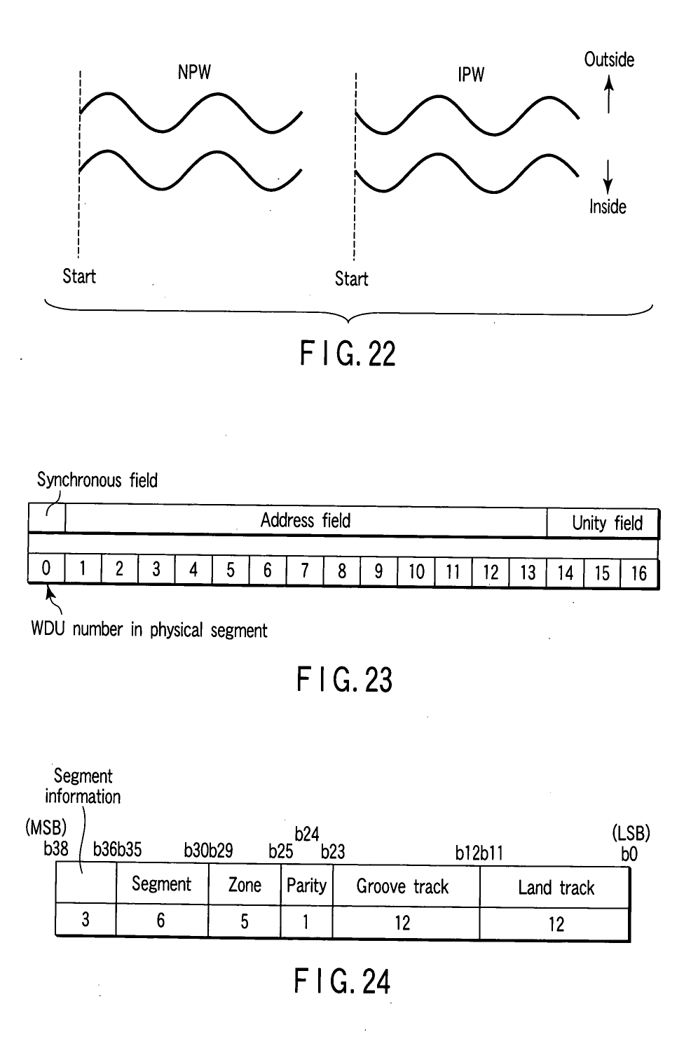

FIG. 22 shows a normal phase wave (NPW) and an invert phase wave (IPW) representing bit modulation regulations. In accordance with this waveform, the wobble signal is recorded in the track. The NPW starts fluctuations outward from the disk, while the IPW starts fluctuations inward from the disk. A start point of the physical segment is equal to a start point of a SYNC area.

The physical segments are aligned at a wobble address in periodic position (WAP) modulated by the wobbles. Each piece of WAP information is indicated by 17 wobble data units (WDUs). A length of the physical segment is equal to 17 WDUs.

Layout of the WAP information is shown in FIG. 23. Numbers in each field indicate WDU numbers in the physical segment. The first WDU number in the physical segment is 0. Layout of an address field in the WAP is shown in FIG. 24.

The wobble SYNC area 580 is bit-synchronized with the start point of the physical segment.

A segment information area is reserved, and all its bits are set to “0b”. This area corresponds to the reserve area 604 in FIG. 21E. The segment information area 601 indicates a physical segment number on the track, and it is generally the maximum number of the physical segment per track.

A data area zone information area 602 indicates zone numbers. The zone information area is “1” in a data read-in area, and “18” in a data read-out area.

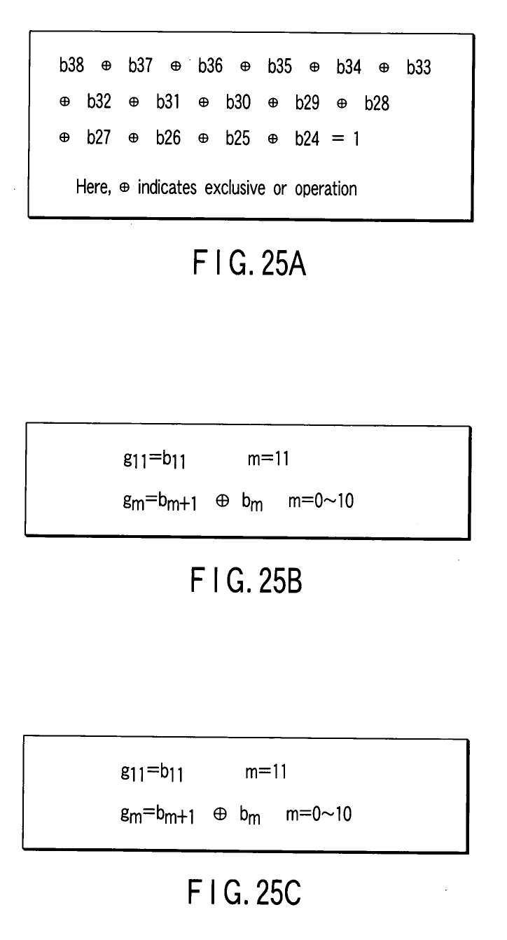

A parity information area 605 is a parity for a segment information field, a segment area and a zone area. In the parity information area 605, a 1-bit error in three fields can be detected, and obtained as shown in a block of FIG. 25A.

The groove track information area 606 indicates the track numbers in the zone when the physical segment is in a groove segment, and recording is performed in the form of gray codes. Each bit of in a groove track field is calculated as shown in a block of FIG. 25B.

gₘ shown in FIGS. 25B and 25C are gray codes converted from bₘ and bₘ₊₁.

All the bits are neglected in a groove track field within a land segment.

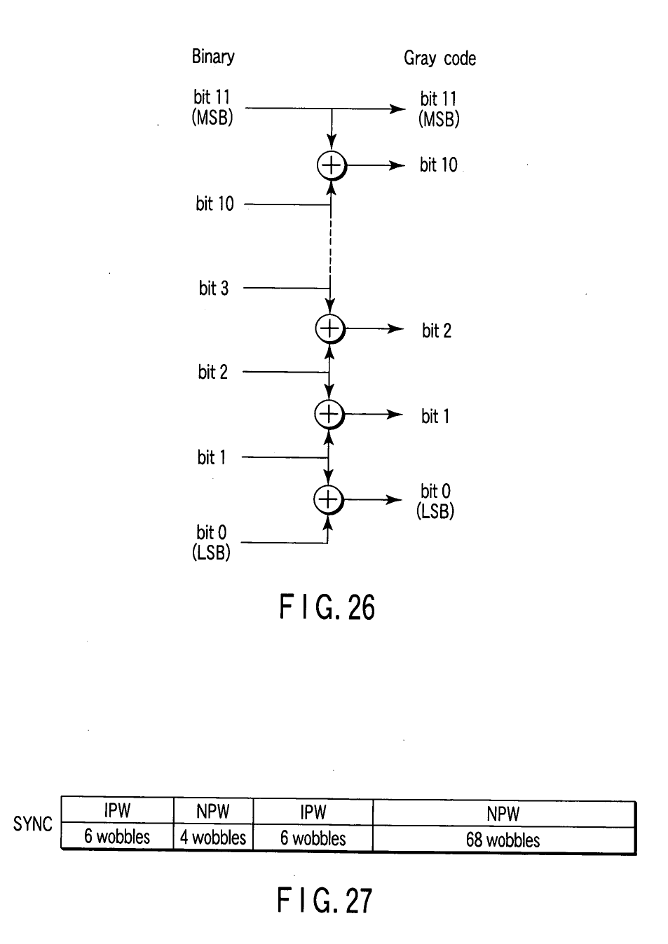

The track information area 607 indicates track numbers in the zone when the physical segment is in a land segment, and recording is performed in the form of gray codes. On the other hand, each bit of in a land track field is calculated as shown in a block of FIG. 25C. It is to be noted that a list of conversion from a binary code to the gray code is indicated in FIG. 26.

As shown in FIG. 27, the wobble data unit (WDU) in a synchronous field has 84 wobbles.

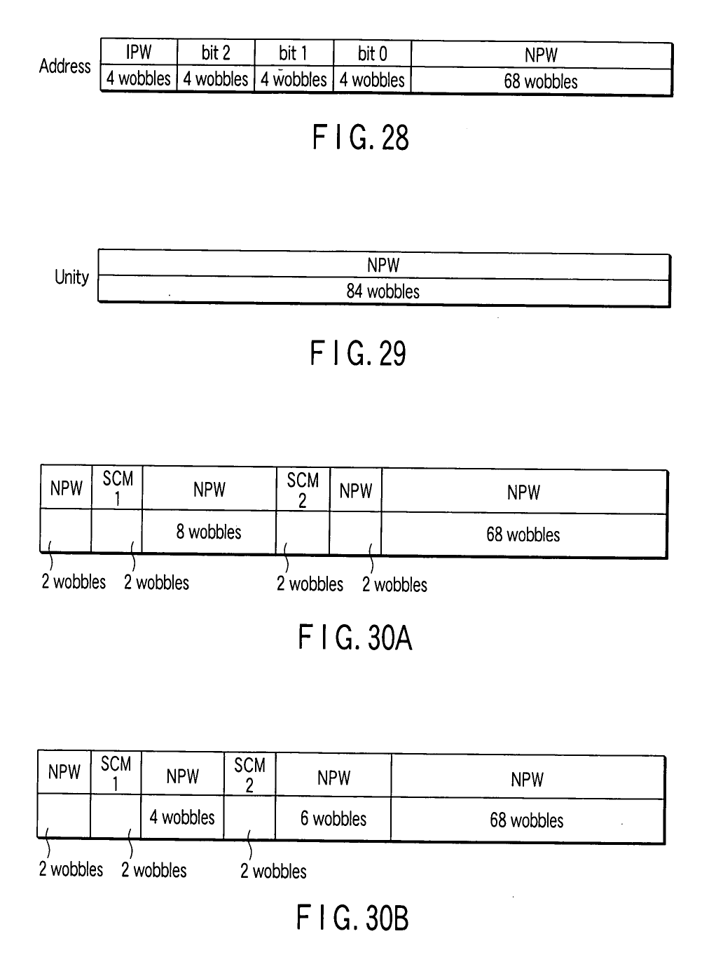

The WDU in the address field is shown in FIG. 28. In 3 bits in the address field, “0b” is recorded for a normal phase wobble NPW, and “1b” is recorded for an invert phase wobble NPW.

The WDU in the unity area is shown in FIG. 29. The WDU in the unity area is not modulated.

The WDU of an outside mark is shown in FIG. 30A.

The WDU of an inside mark is shown in FIG. 30B.

Individual points in the present embodiment and effects unique to the individual points will be described below.

Point [A]:

Physical segment division structure in the ECC block (FIG. 21A to FIG. 21E)

Effect:

Format compatibility is high among the reproduction only type/incremental-writable type/rewritable type, and it is possible to prevent a decrease in error correction capability for the reproduction signal from the recording mark particularly in the rewritable recording medium.

Since the number of sectors 32 and the number of segments 7 constituting the same block are functions that cannot be divided by each other (non-multiple relation), it is possible to prevent a decrease in the error correction capability for the reproduction signal from the recording mark.

Point [B]:

An occupancy ratio of the wobble non-modulation area (590, 591) is higher than that of the wobble modulation area (580 to 587) (FIG. 21D, FIG. 27, FIG. 28).

Effect:

In the present embodiment, a wobble frequency (wobble wavelength) is constant everywhere, and the following is possible by detecting this wobble period;

1) Extraction of the reference clock for detection of the wobble address information (adjustment of the phase to the frequency)

2) Extraction of the reference clock for detection of the reproduction signal during signal reproduction from the recording mark (adjustment of the phase to the frequency)

3) Extraction of the recording reference clock when the recording mark is formed in the rewritable and incremental-writable recording media (adjustment of the phase to the frequency).

The present embodiment depends on the fact that wobble phase modulation is used to pre-record the wobble address information, and if the reproduction signal is passed through the band passfilter for waveform shaping, a detection signal waveform amplitude after shaping decreases “before” and “after” a phase change point. Thus, if frequencies of the phase change point due to the phase modulation increases, a waveform amplitude variation will increase to result in a reduction in the clock extraction accuracy, whereas if the frequency of the phase change point is low in the modulation area, there will be a problem that the bit shift more easily occurs during wobble address information detection.

Therefore, the modulation area and the non-modulation area due to the phase modulation are configured, and the occupancy ratio of the wobble non-modulation area is increased to improve the clock extraction accuracy. Further, in the present embodiment, it is possible to predict a position at which a switch is made between the modulation area and the non-modulation area, so that the non-modulation area is gated during clock extraction to only detect a signal of the non-modulation area, and the clock extraction is facilitated by this detection signal.

Point [C]:

The modulation area is dispersedly arranged, and the wobble address information 610 is dispersedly recorded (FIG. 21D, FIG. 23).

Effect:

If the wobble address information 610 is intensively recorded in one place in the recording medium, it is difficult to detect all the information when a surface has gathered dust or is flawed.

As shown in FIG. 21D, the wobble address information 610 is dispersedly arranged for each of three address bits (12 wobbles) included in one wobble data unit (#0) 560 to (#16) 576, and the information put together for each of the address bits which is an integral multiple of three address bits, thereby providing a structure in which other information can be detected even when the information detection is difficult in one place due to dust and flaws.

Point [D]:

The wobble SYNC information 580 has 12 wobbles (FIG. 21D).

Effect:

A physical length to record the wobble SYNC information 580 is caused to correspond to the address bit length. Further, since one address bit is expressed by four wobbles in the wobble address area, a wobble pattern change is only caused every four wobbles in the wobble address area. In the wobble SYNC information 580, by use of this phenomenon, a wobble pattern change which cannot be caused in the wobble address area is caused, that is, 6 wobbles→4 wobbles→6 wobbles, thereby improving detection accuracy in the wobble SYNC information 580 different from the wobble address area 586, 587.

Point [E]:

The zone information 602 having 5 address bits and the parity information 605 having 1 address bit are arranged adjacently (FIG. 21E).

Effect:

If the zone information 602 having 5 address bits and the parity information 605 having 1 address bit are added, this results in 6 address bits which are an integral multiple of 3 address bits, thereby providing a structure in which other information can be detected even when the information detection is difficult in one place due to dust and flaws.

Point [F]:

The unity area 608 is expressed by 9 address bits (FIG. 21E).

Effect:

It is possible to have the integral multiple of 3 address bits that can be put into the wobble data unit.

Point [G]:

The address information is recorded by land/groove recording plus the wobble modulation.

Effect:

Recording capacity can be maximized. Recording efficiency is increased by forming the recording mark both in the groove and land rather than by forming the recording mark only in the groove.

Furthermore, when the address has been recorded in advance in a state of a pre-pit, the recording mark cannot be formed at a pre-pit position, but the recording mark can also be redundantly recorded on the wobble-modulated groove/land area as in the present embodiment, so that recording efficiency of the recording mark is higher in a address information recording method based on the wobble modulation than in a pre-pit address method. Therefore, a method employing both of the methods above is most suitable for higher capacity.

Point [H]:

The indefinite bits are also dispersedly arranged in the groove area (the track information 606, 607 in FIG. 21E).

Effect:

For a land portion, an area is also defined where a track address is determined without the indefinite bits therein. This enables highly accurate address detection to be also achieved in the land portion.

Point [I]:

The indefinite bits are distributed/arranged in both the land and groove by the land/groove recording plus the wobble modulation (the track information 606, 607 in FIG. 21E).

Effect:

If the indefinite bits are intensively arranged in one of the land and groove, erroneous detection is extremely frequently caused during address information reproduction at a portion where the indefinite bits are intensively arranged. By distributing/arranging the indefinite bits in the land and groove, a risk of erroneous detection is dispersed, and, in total, a system can be provided in which the address information can be easily detected in a stable manner.

Physical segment layout and physical sector layout All of the data read-in area, the data area and the data read-out area have the zones, tracks and physical segments.

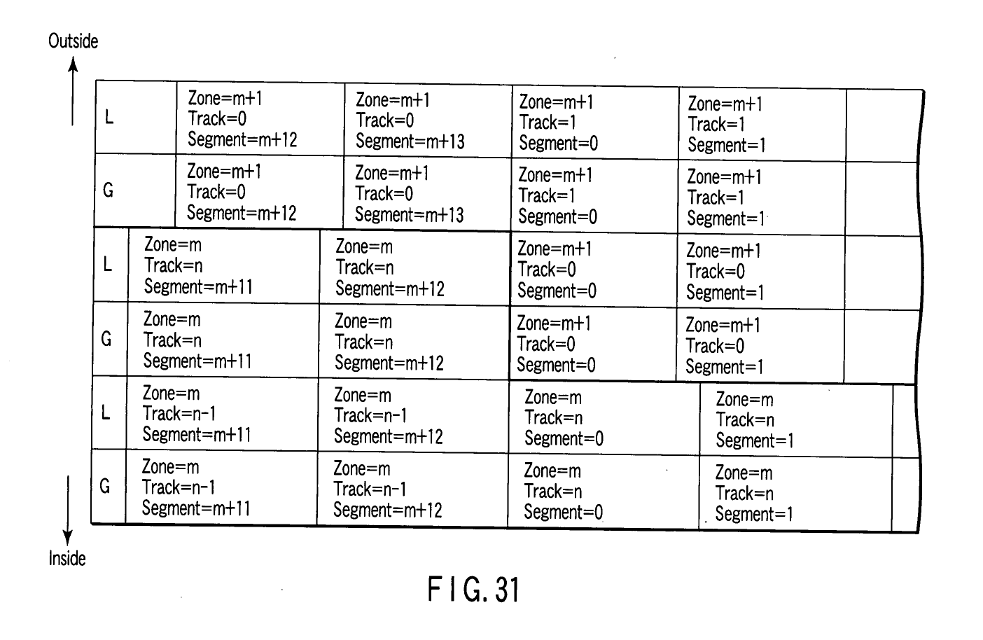

The physical segment is specified by the zone number, the track number and the physical segment number as shown in FIG. 31. The physical segments having the same physical segment number are aligned in each zone. An angular difference between the first channel bits of the physical segments in the adjacent tracks in each zone is within 4 channel bits.

The first physical segments whose physical segment numbers are 0 are aligned between the zones. The angular difference between the first channel bits of two start physical segments in any one of the data read-in area, the data area and the data read-out area is within ±256 channel bits.

The addresses in a land traffic adjacent to a zone boundary are unreadable.

A system read-in area includes a track comprising emboss pit rows. The track in the system read-in area forms a continuous 360-degree spiral. A center of the track is a center of the pit.

The track from the data read-in area to the data read-out area is defined as a continuous 360-degree spiral.

The data read-in area, the data area and the data read-out area include groove track rows and land track rows. The groove track continues from a start of the data read-in area to an end of the data read-out area. The land track continues from the start of the data read-in area to the end of the data read-out area. That is, both the groove track and the land track are continuous spirals. While the groove track is formed as a groove, the land track is not formed as a groove. The groove is trench-shaped, and its bottom is located closer to a reading surface than that of the land.

The disk rotates counterclockwise when viewed from the reading surface. The track is a spiral traveling from an inside diameter to an outside diameter thereof.

Each track in the system read-in area is divided into a plurality of data segments. The data segment includes 32 physical sectors. A length of the data segment in the system read-in area is equal to a length of seven physical segments. Each data segment in the system read-in area has 77469 bytes. The data segments do not include gaps, and are successively placed in the system read-in area. The data segments in the system read-in area are equally arranged on the track so that a space between the first channel bit of one data segment and the first channel bit of the next data segment has 929628 bits.

Each track in the data read-in area, the data area, the data read-out area is divided into a plurality of physical segments. The number of physical segments per track in the data area eventually increases from the inside-diameter zone to the outside-diameter zone so that recording density is constant in every zone. The number of physical segments in the data read-in area is equal to the number of physical segments in a zone 18 in the data area. Each physical segment has 11067 bytes. The physical segments in the data read-in area, the data area, the data read-out area are equally arranged on the track so that a space between the first channel bit of one physical segment and the first channel bit of the next physical segment has 132804 bits.

Physical sector numbers in the system read-in area are decided so that the physical sector number of the last physical sector in the system read-in area is 158719 (“02 6AFFh”).

The physical sector numbers in the land track other than those in the system read-in area are decided so that the physical sector number of the physical sector disposed at a start of the data area located next to the data read-in area is 196608 (“03 0000h”). The physical sector number increases from the start physical sector in the data read-in area to the last physical sector in the data read-out area in the land track.

The physical sector numbers in the groove track other than those in the system read-in area are decided so that the physical sector number of the physical sector disposed at the start of the data area located next to the data read-in area is 8585216 (“83 0000h”). The physical sector number increases from the start physical sector in the data read-in area to the last physical sector in the data read-out area in the groove track.

[Explanation of a Method of Recording/Rewriting Recorded Data]

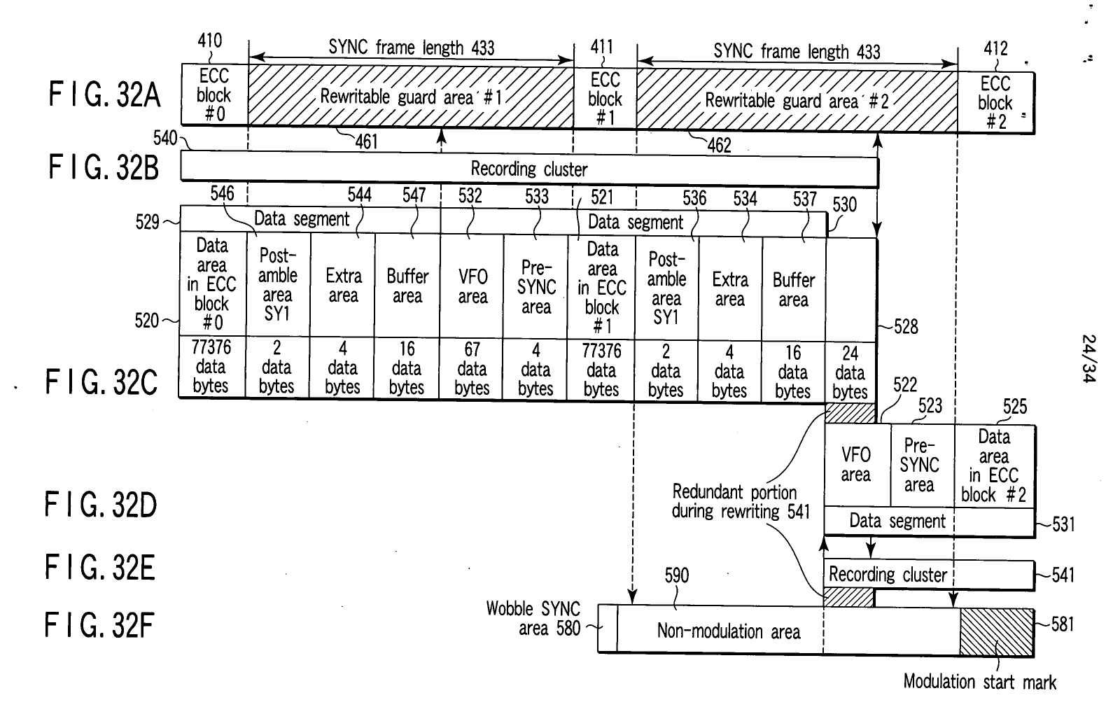

The recording format for rewritable data to be recorded on the rewritable recording medium is shown in FIGS. 32A to 32F. In the present embodiment, the rewritable data is rewritten in a unit of a recording cluster 540, 541 shown in FIGS. 32B and 32E. One recording cluster includes, as described later, one or more data segments 529 to 531, and an extended guard area 528 which is disposed at the end. That is, one recording cluster 531 starts at a start position of the data segment 531 and begins from the VFO area 522. When a plurality of data segments 529, 530 is sequentially recorded, a plurality of data segments 529, 530 is sequentially arranged in the same recording cluster 541 as shown in FIGS. 32B, 32C. In that case, as a buffer area 547 present at the end of the data segment 529 and a VFO area 532 present at the start of the next data segment are continuously connected, the phases of the recording reference clocks during recording in both of the areas coincide with each other. When sequential recording is finished, the extended guard area 528 is disposed at the end position of the recording cluster 540. A data size in the extended guard area 528 before modulation corresponds to 24 data bytes.

As apparent from correspondence between FIG. 32A and FIG. 32C, rewritable guard areas 461, 462 include postamble areas 546, 536, extra areas 544, 534, buffer areas 547, 537, the VFO areas 532, 522 and pre-SYNC areas 533, 523, and the extended guard area 528 is only disposed at a sequential recording end place.

A data arrangement structure in which the guard area is inserted between the optional EEC blocks is common to all of the reproduction only, incremental-writable type and rewritable type recording media. Although not shown, for the incremental-writable type, the data structure in the data segments 490, 531 is common to all of the reproduction only, incremental-writable type and rewritable type recording media. Further, all the data contents in the ECC block 411, 412 have the same type of data structure regardless of the kind of medium such as the reproduction-only recording medium or the incremental-writable type recording medium, and 77376-byte data (the number of bytes of original data before modulation) can be recorded in each of them. That is, the data content of the rewritable data 525 in the ECC block #2 has an ECC block structure. Each of sector data constituting the ECC block comprises 26 SYNC frames.

To compare physical ranges of rewrite units, part of the recording cluster 540 which is the rewrite unit of information is shown in FIG. 32C, and part of the recording cluster 541 which is the next rewrite unit is shown in FIG. 32D. At the redundant portion 541 during rewriting, the extended guard area 528 and the subsequent VFO area 522 are partially overlapping. Thus, the partially overlapping rewriting makes it possible to remove interlayer crosstalk in the recording medium which allows recording in two recording layers on a single side.

The recording cluster 540, 541 is in the data read-in area, the data area, the data read-out area.

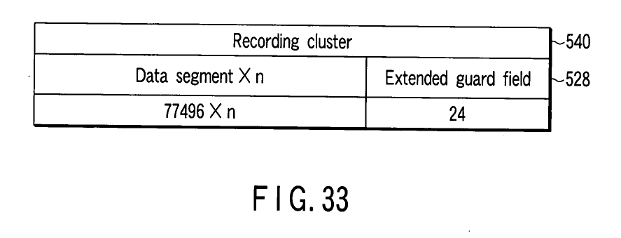

The recording cluster 540, 541 includes one or more data segments 529, 530 and the extended guard area 528 (FIG. 33). A length of the data segment 529, 530 is equal to a length of seven physical segments. The number of recording clusters 540, 541 is one during each recording time. The data segments in the land track do not include gaps. The data segments in the groove track do not include gaps.

A start physical segment number of the data segment is expressed by

{(the number of physical segments per track)×(track number)+(physical segment number)}mod 7=0 wherein mod indicates a remainder of A divided by B when it is indicated as “A mod B”. This equation means that recording is started from a position corresponding to a multiple of 7 in the physical segment.

Layout of the recording cluster 540, 541 is shown in FIG. 33. Numbers in the drawing indicate the length of the area in bytes. “n” in FIG. 33 is 1, or 1 or more.

Data in the extended guard area 528 is “7Eh”, and the modulation pattern in the extended guard area 528 is the following repetitive pattern.

“010001 000100”

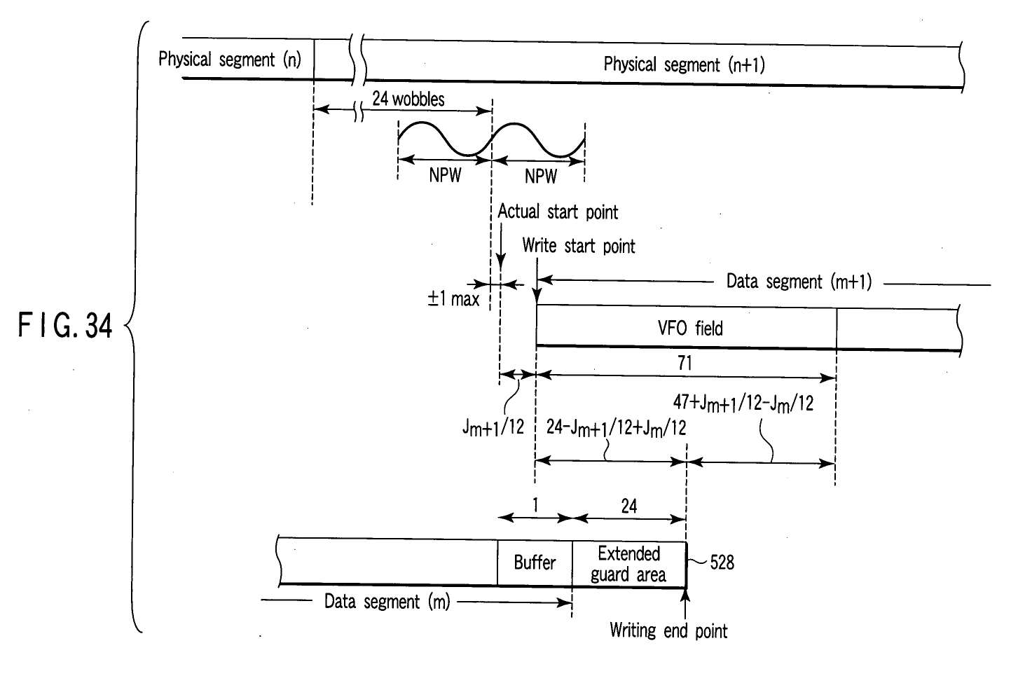

An actual start position of the recording cluster is within ±1 byte regarding a theoretical start position which is 24 wobbles away from a start position of the physical segment. The theoretical start position starts at a start position of the NPW (see FIG. 34).

The start position of the recording cluster is shifted J/12 bytes from the actual start position so that average probabilities of a mark position and a space position on the recording layer will be the same when rewriting is performed many times.

Numbers in FIG. 34 are lengths indicated in bytes. Jₘ randomly changes between 0 and 167, and Jₘ₊₁ randomly changes between 0 and 167.

A rewritable data size in one data segment in the present embodiment is
67+4+77376+2+4+16=77469 [data bytes] (102).

Furthermore, one wobble data unit 560 is
6+4+6+68=84 [wobbles] (103),
and one physical segment 550 is indicated by 17 wobble data units.

Moreover, since a length of 7 physical segments 550 to 556 corresponds to a length of one data segment 531, there are arranged, in one data segment 531,
84×17×7=9996 [wobbles] (104).

Therefore, from Equation (102) and Equation (104),
77496÷9996=7.75 [data bytes/wobbles] (105)
corresponds to one wobble.

As shown in FIG. 34, after 24 wobbles from a front position of the physical segment, there comes a portion in which the next VFO area 522 and the extended guard area 528 overlap each other.

The wobble SYNC area 580 lasts 16 wobbles from a front of the physical segment 550, but subsequent 68 wobbles are within the non-modulation area 590. Thus, the portion after 24 wobbles in which the next VFO area 522 and the extended guard area 528 overlap each other is within the non-modulation area 590.

A phase change type recording film is used for the recording film in the rewritable recording medium in the present embodiment. In the phase change type recording film, the recording film deteriorates in the vicinity of rewrite start/end positions, a rewrite limit is set to the start/end of recording at the same position. Thus, the recording start position is randomly displaced by displacing it for Jₘ₊₁/12 data bytes during rewriting.

To explain a basic concept, a front position of the extended guard area 528 and a front position of the next VFO area 522 coincide with each other, but strictly speaking, the front position of the VFO area 522 is randomly displaced as shown in FIG. 34 in the embodiment.

The phase change type recording film is also used as the recording film in a DVD-RAM disk which is the current rewritable recording medium, and the recording start/end positions are randomly displaced to improve the number of rewriting times. A range of maximum displacement amount for random displacement in the current DVD-RAM disk is set to 8 data bytes. Further, a channel bit length (as data after modulation to be recorded on the disk) in the current DVD-RAM disk is set to 0. 143 μm on average. In the rewritable recording medium in the present embodiment, an average length of a channel bit is
(0.087+0.093÷2=0.090 [μm] (106)

When a length in a physical displacement range is adjusted to the current DVD-RAM disk, a minimum required length as a random displacement range in the present embodiment is, by use of the above value,
8 bytes×(0.143÷0.090)=12.7 [bytes] (107).

Hereinafter, a unit of random displacement amount is adjusted to the channel bit after modulation to ensure facility of reproduction signal detection processing. For example, when the eight to twelve modulation (ETM) is used for conversion from 8 bits to 12 bits, the random displacement amount is expressed, using the data byte as a basis, by Equation:
J_{m/}/12 [data bytes] (108).

Using the value in Equation (107), Jₘ can be valued at
12.7×12=152.4 (109),
and Jₘ is therefore 0 to 152.

From the above reason, the length in the random displacement range corresponds to the current DVD-RAM disk as long as it is in a range satisfying Equation (109), and the number of rewriting times similar to that of the current DVD-RAM disk can be guaranteed. In the present embodiment, to ensure the number of rewriting times higher than the current one, a slight margin is given to the value in Equation (107) as follows:
Length in random displacement range=14 [data bytes] (110).

If the value in Equation (110) is substituted for Equation (108), 14×12=168, thereby setting so that:
Jₘ can be valued at 0 to 167 (111).

In FIGS. 32B and 32C, lengths of the buffer area 547 and the VFO area 532 in the recording cluster 540 are constant. As also apparent from FIGS. 33, in the same recording cluster 540, the random displacement amount Jₘ of the whole data segment 529, 530 is the same at a plurality of positions.

When one recording cluster 540 including a large numbers of data segments therein is sequentially recorded, a recording position is monitored from the wobbles. That is, while a position of the wobble SYNC area 580 is detected or the number of wobbles is counted in the non-modulation area 590, 591, the recording position on the recording medium is checked simultaneously with the recording of data. At this point, a wobble slip (recording at a position displaced by one wobble cycle) is caused due to erroneous counting of the wobbles or irregular rotation of an unshown motor which rotates the recording medium, and the recording position on the recording medium is thus sometimes displaced.

When the recording position displacement thus caused is detected, recording timing is corrected in the rewritable guard area 461 (recording timing is adjusted).

In FIG. 32C, important information which cannot permit a lack of bits or bit redundancy is recorded in the postamble area 546, the extra area 544 and the pre-SYNC area 533, but the particular pattern is repeated in the buffer area 547 and the VFO area 532, so that the lack or redundancy of one pattern alone is permitted as long as this repeated boundary position is secured. That is, the recording timing can be corrected in the guard area 461, particularly in the buffer area 547 or the VFO area 532.

As shown in FIG. 34, in the present embodiment, the actual start position which will be the basis for position setting is set to correspond to a position of a wobble amplitude “0” (center of wobbles). However, the detection accuracy of the wobble position is low, so that in the present embodiment,
Actual start point position=displacement up to ±1 [data byte] at the maximum (112)
is permitted, in accordance with “±1 max”.

As described above, a random shift amount in the data segment 530 is Jₘ (the random shift amounts of the whole data segment 529 coincide in the recording cluster 540 as described above), and then the random shift amount of the incrementally written data segment 531 is set to Jₘ₊₁. For example, an intermediate value is taken as possible value of Jₘ and Jₘ₊₁ shown in Equation (111), and when Jₘ+Jₘ₊₁=84 and accuracy of the actual start point position is sufficiently high, a start position of the extended guard area 528 and a start position of the VFO area 522 coincide with each other.

On the contrary, when the data segment 530 is recorded at a maximum rear position and the data segment 531 which will be incrementally written or rewritten later is recorded at a maximum front position, a front position of the VFO area 522 may break into the buffer area 537 up to 15 data bytes, in accordance with the value specified in Equation (110) and the value in Equation (112). Particular important information is recorded in the extra area 534 immediately before the buffer area 537. Therefore,
Length of the buffer area 537 . . . 15 [data bytes] or more (113)
is required. Thus, with a margin of 1 data byte, a data size in the buffer area 537 is set to 16 data bytes.

As a result of the random shift, if a space is produced between the extended guard area 528 and the VFO area 522, the interlayer crosstalk during reproduction is caused by the space when the structure with two recording layers on the single side is employed. Thus, it is designed not to produce the space in such a manner that the extended guard area 528 and the VFO area 522 partially overlap each other regardless of the result of the random shift. Therefore, in the present embodiment, a length of the extended guard area 528 needs to be 15 data bytes or more from the same reason as that shown in Equation (113).

On the other hand, the subsequent VFO area 522 has sufficiently long 71 data bytes, so that even if the area where the extended guard area 528 and the VFO area 522 overlap each other is somewhat large, no trouble is caused during signal reproduction (because sufficient time is secured to synchronize the reproduction reference clock in the VFO area 522 which does not overlap). Thus, the extended guard area 528 can be set to a value larger than 15 data bytes.

It has already explained that during sequential recording, the wobble slip sometimes occurs, and the recording position may be displaced by one wobble cycle. As shown in Equation (105), since one wobble cycle corresponds to 7.75 (about 8) data bytes, this value is taken into account in Equation (113) to set as follows:
Length of the extended guard area 528=(15+8=)23 data bytes or more (114)
A margin of 1 data byte is considered in the same manner as in the buffer area 537, and the length of the extended guard area 528 is set to 24 data bytes.

In FIG. 32E, since it is necessary to accurately set the recording start position of the recording cluster 541, the recording start position is detected using the wobble signal recorded in advance. Except for the wobble SYNC area 580, all the patterns change from the NPW to the IPW in a four-wobble unit. By comparison, a switching unit of the wobble is partly deviated from four wobbles in the wobble SYNC area 580, and the position detection is most easily performed in the wobble SYNC area 580.

From this, preparation of recording is started after the position of the wobble SYNC area 580 can be detected, thus performing recording. Therefore, the start position of the recording cluster 541 needs to be put into the non-modulation area 590 immediately after the wobble SYNC area 580.

FIG. 34 shows contents thereof.

The wobble SYNC area 580 is disposed immediately after a change of the physical segments. A length of the wobble SYNC area 580 corresponds to 16 wobble cycles. Further, after detection of the wobble SYNC area 580, 8 wobble cycles are secured to allow a margin to prepare recording. Therefore, as shown in FIG. 34, the front position of the VFO area 522 present at a front position of the recording cluster 541 is disposed 24 wobbles or more ahead from a “change point” of the physical segments, considering the random shift.

Recording processing is performed many times at the redundant portion 541 during rewriting. As has already been described, if rewriting is repeated, a wobble groove or a wobble land changes (deteriorates) in physical shape, and wobble reproduction signal quality drops from that point.

Hence, the redundant portion 541 during rewriting is prevented from being located in the wobble SYNC area 580 or in the wobble address area 586, and data recording is controlled so that it is located in the non-modulation area 590. This focuses attention on the fact that the non-modulation area 590 is a repetition of the fixed wobble patterns (NPW), and takes advantage of the fact that even if the wobble reproduction signal quality partially deteriorates, it can be complemented by use of precedent and subsequent wobble reproduction signals.

[Explanation of Individual Points of the Embodiment and Effects Unique to the Individual Points]

Point [J]:

Recording is performed with partial overlap in the guard area in the recording format for the recordable recording medium. The extended guard area 528 and the subsequent VFO area 522 overlap each other, thereby producing the redundant portion 541 during rewriting.

Effect:

If there is a space (part where the recording mark is not present) between the precedent and subsequent guard areas in the segment, a difference of light reflectivity is caused depending on whether or not the recording mark is present, so that the difference of light reflectivity is caused at the space portion in broad perspective. Thus, in a case of the structure with two recording layers on the single side, information reproduction signals from other layers are disturbed due to an influence from the space portion, and errors during reproduction frequently occur. As in the present embodiment, owing to the partial overlap of the guard area, the space where the recording mark is not present is prevented from being produced, and effects of the interlayer crosstalk from the recorded area in two recording layers on the single side can be removed, thereby obtaining the stable reproduction signal.

Point [K]:

The redundant portion 541 during rewriting is set to be recorded in the non-modulation area 590.

Effect:

Since the position of the redundant portion 541 during rewriting is set to be within the non-modulation area 590, the wobble reproduction signal quality is prevented from deteriorating due to shape deterioration in the wobble SYNC area 580 or in the wobble address area 586, and it is possible to guarantee stable wobble detection signal from the wobble address information 610.

Point [L]:

The VFO area in the data segment starts after 24 wobbles from the front of the physical segment. The extended guard area 528 is formed at the end of the recording cluster representing the rewrite unit.

Effect:

By forming the extended guard area 528 at the end of the recording cluster, the precedent recording cluster 540 and the subsequent recording cluster 541 can be set to partially overlap each other without fail, in FIG. 32C. Because no space is produced between the precedent recording cluster 540 and the subsequent recording cluster 541, the reproduction signal from the recording mark can be stably provided without being affected by the interlayer crosstalk in the rewrite type or incremental-write type recording medium having two recording layers on the single side, thereby making it possible to ensure reliability during reproduction.

Point [M]:

A dimension of the extended guard area 528 is 15 data bytes or more.

Effect:

From the reason in Equation (113), no space is made between the recording clusters 540, 541 even by the random shift, so that the reproduction signal from the recording mark can be stably provided without being affected by the interlayer crosstalk.

Point [N]:

The dimension of the extended guard area 528 is 24 data bytes.

Effect:

From the reason in Equation (114), no space is made between the recording clusters 540, 541 even when the wobble slip is considered, so that the reproduction signal from the recording mark can be stably provided without being affected by the interlayer crosstalk.

Point [O]:

The random shift amount is in a range greater than Jₘ/12 (0≦Jₘ≦154).

Effect:

Equation (109) is satisfied, and a length in a physical length for the random shift amount corresponds to the current DVD-RAM, the number of repeated recording times similar to that if the current DVD-RAM can be guaranteed.

Point [P]:

A size of the buffer area is set to 15 data bytes or more.

Effect:

From the reason in Equation (113), overwriting is not performed in the VFO area 522 adjacent to the extra area 537 even by the random shift, and data reliability in the extra area 534 is secured.

Point [Q]:

The recording cluster representing the rewrite unit comprises one or more data segments.

Effect:

Mixed recording processing performed on the same recording medium is facilitated for PC data (PC files) which is often rewritten many times in small quantity and for AV data (AV files) which is sequentially recorded in large quantity at a time.

Data used for personal computers are often rewritten many times in relatively small quantity. Therefore, if a data unit for rewriting or incremental writing is set to be as small as possible, a recording method suitable for the PC data can be provided. In the present embodiment, 32 sectors constitute the ECC block. If rewriting or incremental writing is performed in a data segment unit including only one ECC block, this results in a minimum unit in which rewriting or incremental writing is efficiently performed. Thus, the structure in the present embodiment in which the recording cluster representing the rewrite unit includes one or more data segment is a recording structure suitable for the PC data (PC files). In the AV data (AV files), a significantly large amount of video information or audio information needs to be sequentially recorded in a seamless manner. In this case, data to be sequentially recorded are collectively recorded as one recording cluster. If the random shift amount, a structure in the data segment, attributes of the data segment or the like is changed for each of the data segments constituting one recording cluster when the AV data is recorded, time is required for changing processing, which causes difficulty in the sequential recording processing.

In the present embodiment, the data segments in the same format (without changing the attributes or the random shift amount and without inserting particular information between the data segments) are successively arranged to configure the recording cluster, whereby it is possible to provide the recording format suitable for AV data recording in which a large quantity of data is sequentially recorded, and the structure in the recording cluster is simplified to achieve simplification of a recording control circuit and a reproduction detection circuit, thus making it possible to reduce costs of the information recording/reproduction apparatus or the information reproduction apparatus.

Furthermore, the data structure in which the data segments 529, 530 in the recording cluster 540 (except for the extended guard area 528) are sequentially arranged is totally the same as that of the reproduction-only recording medium. Although not shown, the same structure is also provided in the incremental-write type recording medium in the present embodiment. Thus, the data structure is common to all the recording media regardless of whether they are the reproduction only/incremental-write type/rewritable type media, so that compatibility of media is secured; the same detection circuit can be used in the information recording/reproduction apparatus or the information reproduction apparatus with secured compatibility; high reproduction reliability can be secured; and lower costs can be achieved.

Point [R]:

In the same recording cluster, the random shift amounts of the whole data segment coincide.

Effect:

When reproduction is performed over different data segment in the same recording cluster, synchronization (reset of the phase) in the VFO area is not needed, and it is possible to simplify a reproduction detection circuit for sequential reproduction and to secure high reliability in reproduction detection.

Point [S]:

The recording timing is corrected in the guard area between the ECC blocks.

Effect:

Data in an ECC block 410 and the ECC block 411 is data targeted for correction in the data structure, and basically, even a lack of one bit of data is not desired. By comparison, since data in the buffer area 547 or the VFO area 532 is a repetition of the same pattern, no problem occurs even if a partial lack or partial redundancy is caused while break points of repetitions are secured. Therefore, if recording displacement is detected during sequential recording, the recording timing is corrected in the guard area 461, so that recording control or reproduction control can be stably performed without affecting the data in the ECC block 410, 411.

Point [T]:

The recording cluster start position is recorded from the non-modulation area immediately after the wobble SYNC area.

Effect:

Since the recording of the wobble SYNC area 580 which is most easily detected is started immediately after detection, accuracy of the recording start position is high and stable recording processing is possible.

Point [U]:

Recording is started from a position displaced 24 wobbles or more from the change position of the physical segments.

Effect:

Since it is possible to properly take detection time for the wobble SYNC area 580 and preparation time for the recording processing, stable recording processing can be guaranteed.

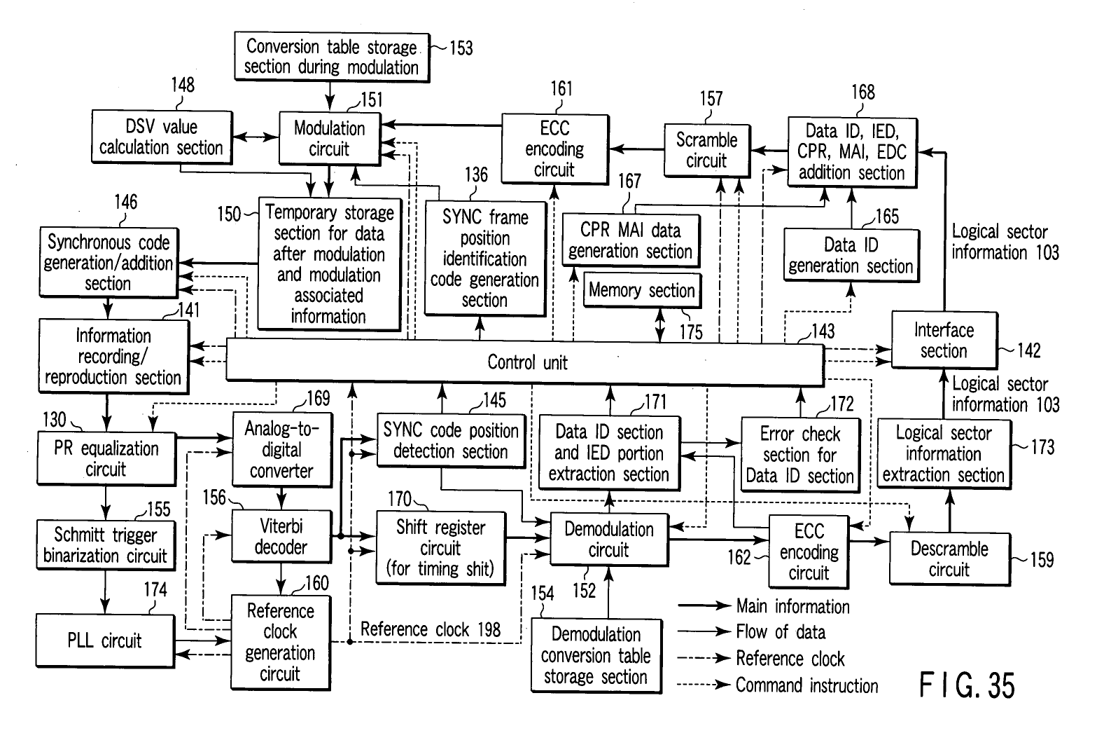

FIG. 35 more specifically shows an entire configuration of the information reproduction apparatus or the information recording/reproduction apparatus.

The optical head is disposed in an information recording/reproduction section 141, but it is omitted.

In the present embodiment, channel bit spaces are reduced close to the maximum for higher density of the recording medium. As a result, for example, a pattern “101010101010101010101010” which is a repetition of a pattern of d=1 is recorded on the recording medium, and when this data is reproduced in the information recording/reproduction section 141, it is close to a cutoff frequency of an MTF characteristic of a reproduction optical system, so that the amplitude of the reproduction signal is almost buried in noise. Therefore, the partial response maximum likelihood (PRML) is used, as has been described, as a method of reproducing the recording mark or pit whose density is thus increased close to a limit (cutoff frequency) of the MTF characteristic.

That is, a signal reproduced from the information recording/reproduction section 141 is subjected to reproduction waveform correction by a PR equalization circuit 130. In an A/D converter 169, the signal after passing through the PR equalization circuit 130 is sampled in response to timing of a reference clock 198 sent from a reference clock generation circuit 160, and converted into a digital quantity, and the signal is then subjected to Viterbi decoding processing in a Viterbi decoder 156. Data after the Viterbi decoding is processed as binarized data at a predetermined slice level. When the PRML technique is employed, an error rate of the data after the Viterbi decoding increases if sampling timing in the A/D converter 169 is delayed. Therefore, in order to increase accuracy of the sampling timing, particularly, the information reproduction apparatus or the information recording/reproduction apparatus in the present embodiment separately has a sampling timing extraction circuit (combination of a schmitt trigger binary circuit 155 and a PLL circuit 174).

In the information reproduction apparatus or the information recording/reproduction apparatus in the present embodiment, the schmitt trigger circuit is used for the binarizing circuit, so that a specific width (actually, a forward voltage value of a diode) is included in the slice reference level for binarization. This apparatus is characterized in that the data is binarized only when it exceeds the specific width. Therefore, as described above, for example, when the pattern “101010101010101010101010” is input, the signal amplitude is very small, so that the binarization change is not caused. If a pattern such as “1001001001001001001001” which are less favored is input, the amplitude of the reproduction signal is increased, so that polarity of the binarized signal is changed in the schmitt trigger binary circuit 155 in response to timing of “1”. Further, as a non-return-to-zero invert (NRZI) method is employed, a position of “1” in the above pattern coincides with the recording mark or an edge (boundary) of the pit.

In the PLL circuit 174, a difference in frequency and phase between the binarized signal which is an output of the schmitt trigger binarization circuit 155 and a signal of the reference clock 198 sent from the reference clock generation circuit 160 is detected to change the frequency and phase of an output clock of the PLL circuit 174. In the reference clock generation circuit 160, the output signal of the PLL circuit 174 and decoding characteristic information for the Viterbi decoder 156 (information on a convergence length (distance to convergence) in a path metric memory in the Viterbi decoder 156, but this is not specifically shown) are used to give feedback to (the frequency and phase of) the reference clock 198 so that the error rate after the Viterbi decoding decreases.

In all of an ECC encoding circuit 161, an ECC encoding circuit 162, a scramble circuit 157, and a descramble circuit 159 in FIG. 25, processing is performed in a 1-byte unit. If 1-byte data before modulation is modulated in accordance with the (d, k; m, n) modulation regulation (this means RLL (d, k) in m/n modulation in the above-mentioned description method), a length after modulation is
8n÷m (201).

Therefore, if a data processing unit in the above circuit is converted by a after-modulation processing unit, a processing unit of SYNC frame data 106 after modulation is given by Equation (201). It is to be noted that if integrity of processing is intended between the SYNC code and the SYNC frame data after modulation, a data size (channel bit size) of the SYNC code needs to be set to an integral multiple of Equation (201). Therefore,
8Nn÷m (202)
is used as a size of a SYNC code 110 (N means an integral value in Equation (202)), thereby ensuring the integrity of processing between the SYNC code 110 and the SYNC frame data 106 after modulation.

It is to be noted that d=1, k=10, m=8, n=12, and if these values are substituted for Equation (202), a total data size of the SYNC code 110 is
12N (203).

A SYNC code size of current DVD is 32 channel bits, so that by causing the total data size of the SYNC code to be smaller than 32 channel bits, processing is simplified and reliability in position detection/information identification can be improved. Thus, the total data size of the SYNC code is 24 channel bits as shown in FIGS. 15A and 15B.

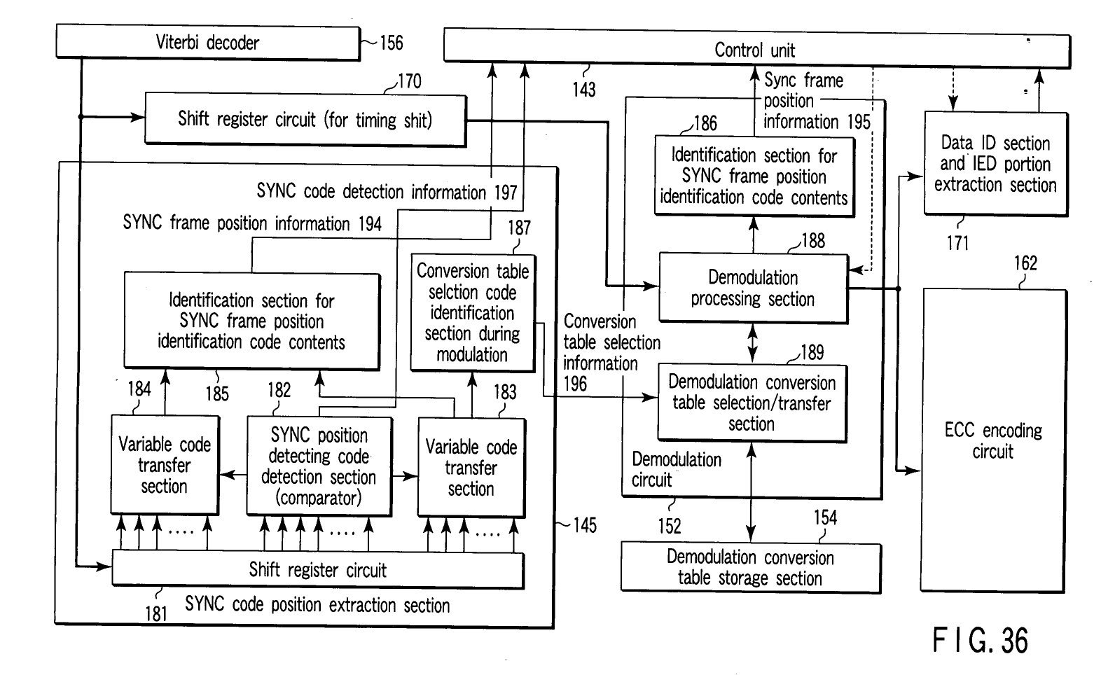

FIG. 36 shows a diagram to explain a detailed configuration around a SYNC code position detection section 145.

Using FIG. 35 to FIG. 40, a description is given to a method of determining a position in the physical sector of currently reproduced data by use of an arrangement of precedent and subsequent information in successive three SYNC codes in accordance with the SYNC code arrangement method indicated above.

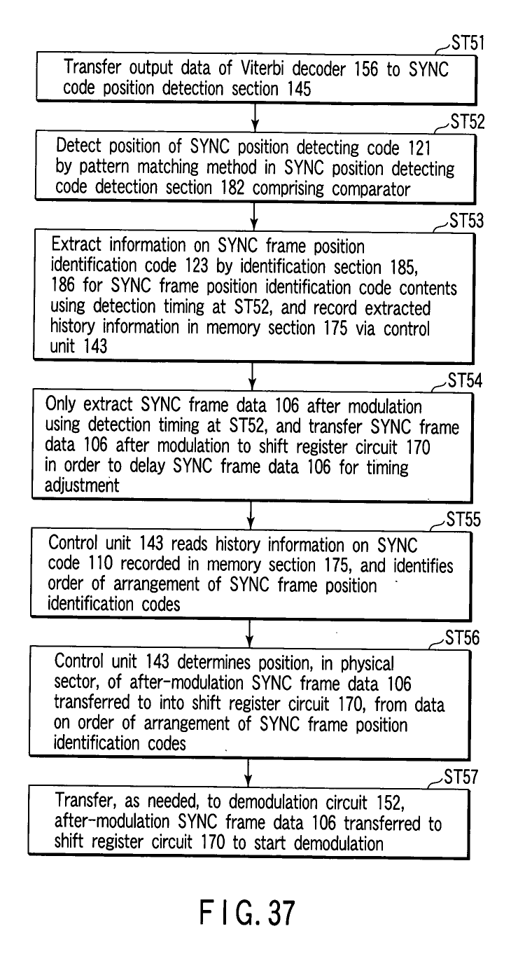

Output data of the Viterbi decoder 156 as shown in FIG. 36 detects a position of the SYNC code 110 in the SYNC code position detection section 145 (ST51, ST52 in FIG. 37). Then, detected information on the SYNC code 110 is sequentially stored in a memory section 175 via a control unit 143 (ST53 in FIG. 37).

If the position of the SYNC code 110 can be recognized, the SYNC frame data 106 after modulation alone is extracted from the data output from the Viterbi decoder 156 and can then be transferred to a shift register circuit 170 (ST54 in FIG. 37). Next, the control unit 143 reads history information regarding on the SYNC code 110 recorded in the memory section 175, and identifies an order of arrangement of SYNC frame position identification codes (ST55 in FIG. 37), and then determines the position, in the physical sector, of the SYNC frame data 106 after modulation temporarily stored in the shift register circuit 170 (ST56 in FIG. 37).

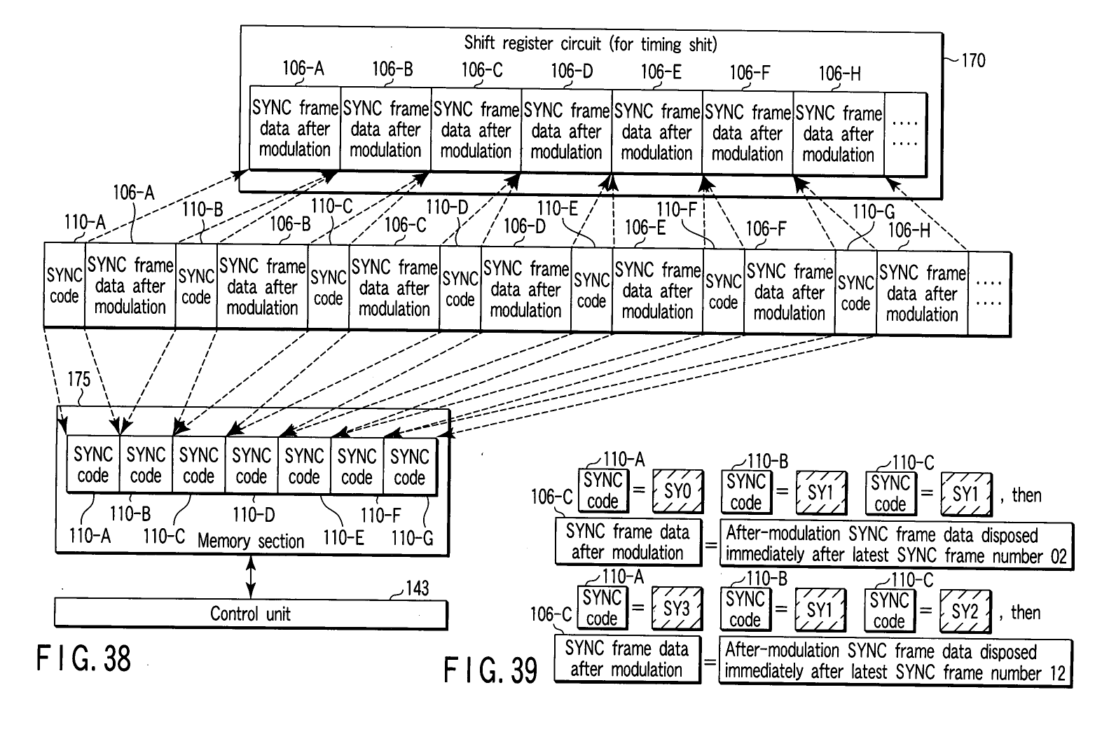

For example, it can be determined (by using the slicer shown in FIG. 42) that if the arrangement of the SYNC codes stored in the memory section 175 as shown in FIG. 38 is SY0→SY1→SY1 as shown in FIG. 39, there exists, immediately after last SY0, the SYNC frame data after modulation disposed immediately after a latest SYNC frame number 02, and if

SY3→SY1→SY2, there exists, immediately after last SY2, the SYNC frame data after modulation disposed immediately after a latest SYNC frame number 12.

The position in the sector is thus determined, and if it can be confirmed that the SYNC frame data 106 after modulation at a desired position has been input in the shift register circuit 170, that data is transferred to a demodulation circuit 152 to start demodulation (ST57).

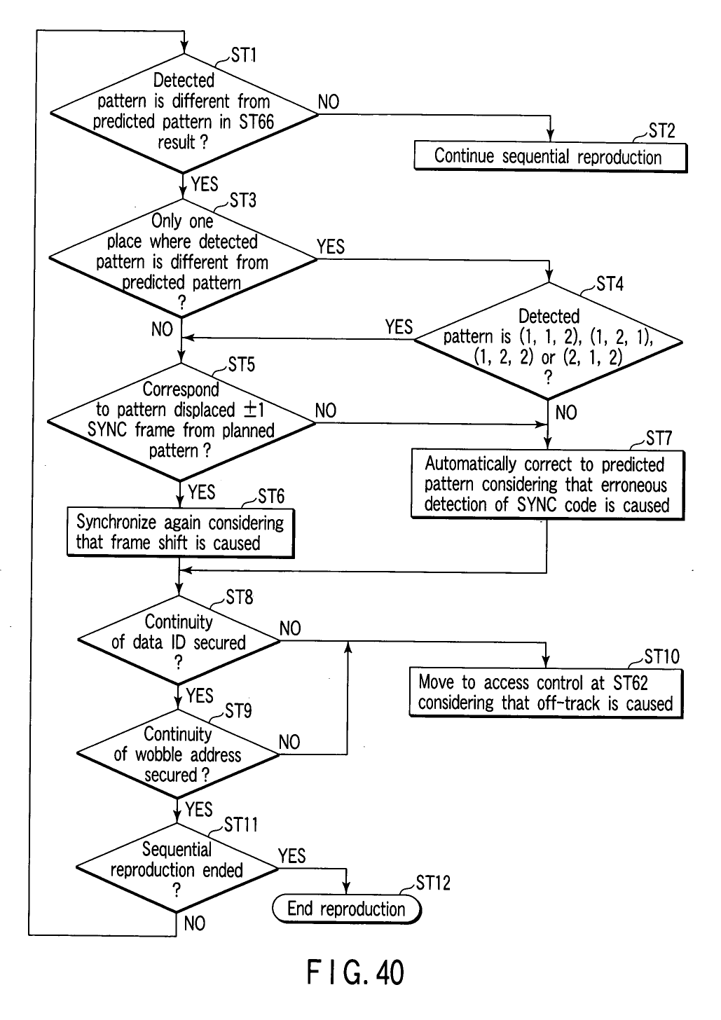

A phenomenon speculation method and a coping method are shown in FIG. 40 for a case where a combination pattern of the SYNC code thus detected is different from a prediction. In the present embodiment, speculation is made using a relation explaining diagram in FIG. 38. A characteristic shown in FIG. 40 is that a judgment is made about whether or not there is only one place where the combination pattern of the detected SYNC code is different from the prediction (ST3). If there is only one place with such a difference, it is highly likely that a frame shift has been caused when the detected pattern is one of (1, 1, 2), (1, 2, 1), (1, 2, 2), (2, 1, 2), and if not so, it can be understood that the SYNC code has been erroneously detected.

On the basis of the above judgment result, synchronization is again performed (ST6) when the frame shift has been caused, or when that the SYNC code has been erroneously detected, the erroneously detected SYNC code is automatically corrected in accordance with a predicted value (ST7). Further, continuity of data IDs (ST8) and continuity of the wobble addresses (ST9) are checked at the same time. It is to be noted that a off-track detection and a response to occurrence of an off-track (ST10) will be separately described.

As described above, while a signal is detected using a level slice method in the system read-in area, a signal is detected using the PRML method in the data read-in area, the data area, the data read-out area.

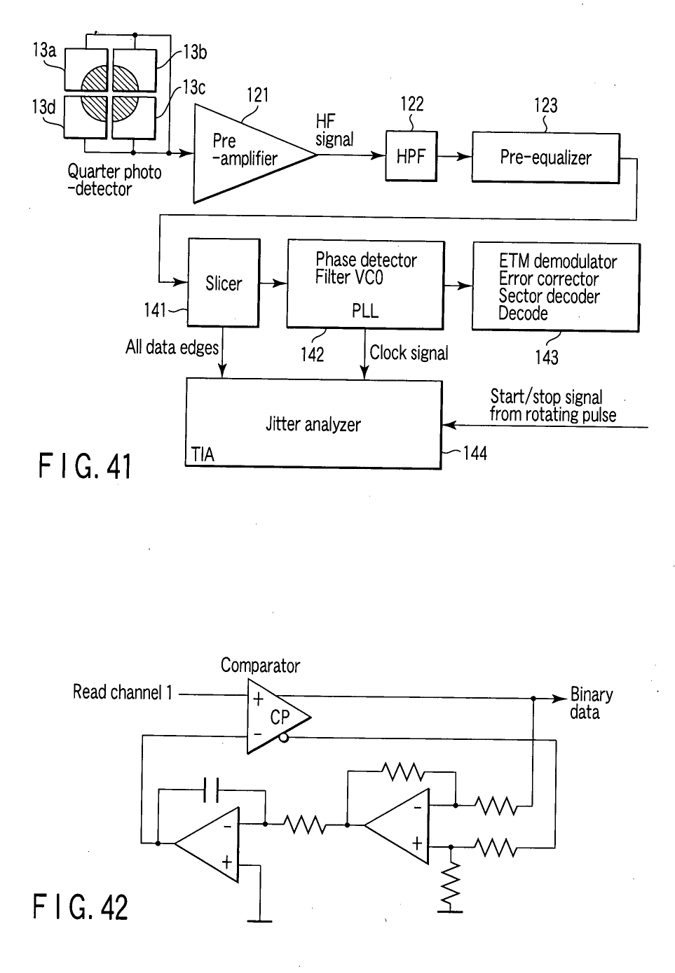

FIG. 41 shows a signal detection/signal evaluation circuit used to reproduce a signal in the system lead-in area.

The outputs from quarter photo-detectors 13a to 13d are summed up, and the summed-up output is caused to pass through a high pass filter (HPF) 122, and subjected to level slicing by a slicer 141 after the waveform thereof is corrected by a pre-equalizer 123.

The circuit shown in FIG. 41 has the following circuit characteristics.

(1) Phase lock loop (PLL)
Natural frequency at 4T: ωₙ=300 Krads/sec
Damping ratio at 4T: δ=0.70

(2) High pass filter (HPF)
Primary fc (−3 dB)=1.0 KHz

(3) Pre-equalizer

For example, the pre-equalizer is a seven-order equiripple filter and has a boot level k1 of 9.0±0.3 dB and a cut-off frequency of 16.5±0.5 MHz as frequency characteristics. In addition to the above, the circuit shown in FIG. 41 has the following circuit characteristics.

(4) Slicer
Duty feedback method: fc=5.0 KHz

(5) Jitter

A jitter is measured while a disk makes a quarter rotation in a frequency zone of from 1.0 KHz to HF.

FIG. 42 is a circuit diagram showing a specific circuit used in the slicer shown in FIG. 41 that acts as a portion where the level slicing is executed.

In the circuit, fundamentally, a signal output from the pre-equalizer (read channel 1) is binarized using a comparator.

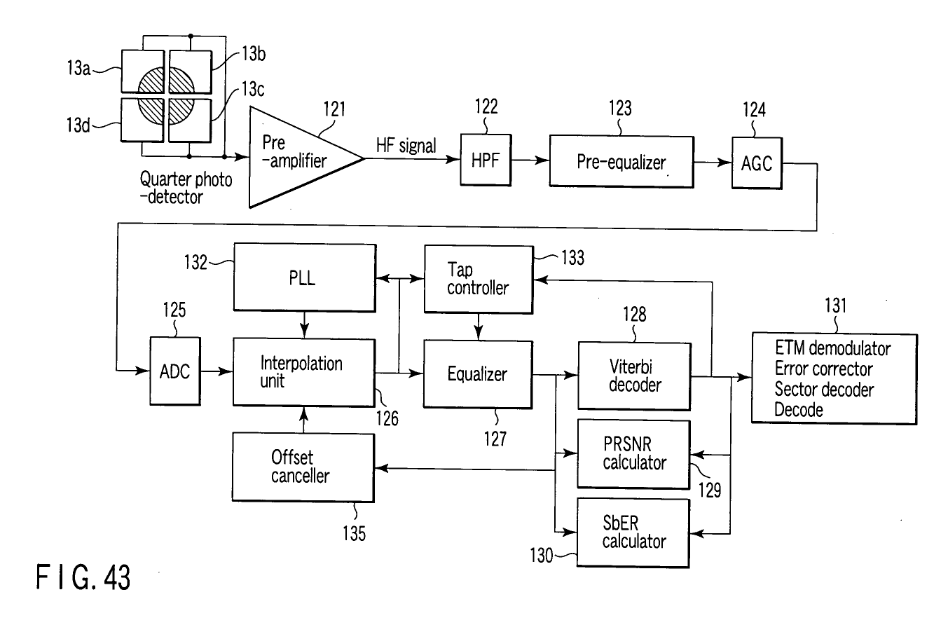

A signal is detected in the data lead-in area, the data area, and the data lead-out area of the recording medium using the PRML method, and FIG. 43 shows a circuit diagram of a circuit for detecting the signal. In FIG. 43, the output from quarter photo-detectors are summed up, the summed-up output is caused to pass through a high pass filter 122, and the signal waveform of the summed-up output is used after the waveform is corrected by a pre-equalizer 123, similarly to the circuit arrangement shown in FIG. 41. However, as shown in FIG. 43, a circuit before the output is supplied to a PRML circuit is characterized in that the amplitude of a reproduced signal is controlled to a given level using an automatic gain control (AGC) circuit 124.

In the circuit shown in FIG. 43, the analog signal is converted into a digital signal by an analog to digital converter (ADC) circuit. The characteristics of the circuit shown in FIG. 43 are summarized as shown below.

(1) Phase lock loop (PLL)
Natural frequency at 4T: ωₙ=580 Krads/sec
Damping ratio at 4T: δ=1.1

(2) High pass filter (HPF)
Primary fc (−3 dB)=1.0 KHz

(3) Pre-equalizer

For example, the pre-equalizer is a seven-order equiripple filter and has a boot level k1 of 9.0±0.3 dB and a cut-off frequency of 16.5±0.5 MHz as frequency characteristics.

(4) Automatic gain control (AGC)
−3 dB closed loop zone: 100 Hz

(5) Analog to digital conversion (ADC)

Relationship between ADC and the dynamic range of an HF signal
Sample clock: 72 MHz
Resolution: 8 bits, I₁₁₁ level: 64±5
I₁₁₁ level: 192±5

(6) Equalizer

A 9-tap transversal filter is used as an equalizer. A coefficient is controlled by a tap controller.
Resolution of tap coefficient: 7 bits
Resolution of equivalent signal: 7 bits

(7) Tap controller

The tap coefficient of the equalizer is calculated by a minimum square error (MSE) algorithm. An initial value is used as the tap coefficient before it is calculated.

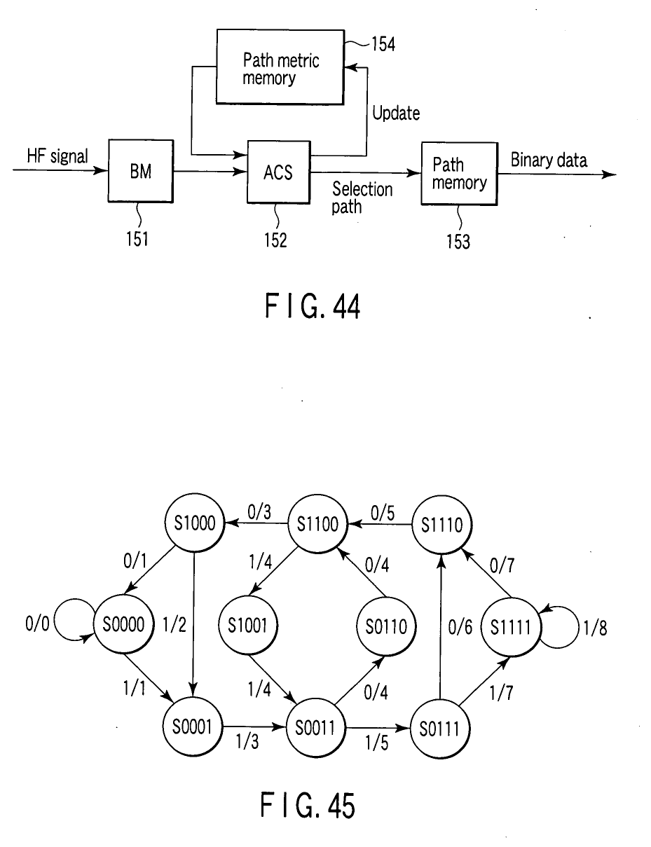

FIG. 44 shows the structure of a Viterbi decoder 128 used in the signal evaluation circuit shown in FIG. 43. In this embodiment, PR(1,2,2,2,1) is employed as a PR class.

The read channels from the data lead-in area, the data area, and the data lead-out area are combined with an ETM code so as to be in conformity with a PR(1,2,2,2,1) channel.

FIG. 45 shows the transition of state of the PR channel.

Sabcd indicates that a previously input 4 bits are abcd, and e/f shows that next input data is e and a signal level is f.

The Viterbi decoder outputs binary data from an equivalent signal as shown below.

A branch metric at a time t is calculated as shown below.
BM(t, i)=(yₜ−i)²
where, yₜ shows an HF signal after it is equalized, and i=0, 1, . . . 8.

The resolution of the branch metric is equal to or larger than 10 bits.

As shown in FIG. 45, the path metric at time t is calculated as shown below.
PM(t, S0000)=min{PM(t−1, S0000)+BM(t, 0), PM(t−1, S1000)+BM(t, 1)}
PM(t, S0001)=min{PM(t−1, S0000)+BM(t, 1), PM(t−1, S1000)+BM(t, 2)}
PM(t, S0011)=min{PM(t−1, S0001)+BM(t, 3), PM(t−1, S1001)+BM(t, 4)}
PM(t, S0110)=PM(t−1, S0011)+BM(t, 4) PM(t, S0111)=PM(t−1, S0011)+BM(t, 5)
PM(t, S1000)=PM(t−1, S1100)+BM(t, 3) PM(t, S1001)=PM(t−1, 11000)+BM(t, 4)
PM(t, S1100)=min{PM(t−1, S0110)+BM(t, 4), PM(t−1, S1110)+BM(t, 5)}
PM(t, S1110)=min{PM(t−1, S0111)+BM(t, 6), PM(t−1, S1111)+BM(t, 7)
PM(t, S1111)=min{PM(t−1, S0111)+BM(t, 7), PM(t−1, S1111)+BM(t, 8)

The resolution of the path metric is equal to or larger than 11 bits.

An add-compare-select block calculates a new path metric, supplies the new path metric to a path metric memory, and supplies a selection to a path memory.

select 0=0
(case of (PM(t−1, S0000)+BM(t, 0)<PM(t−1, S1000)+BM(t, 1))

select 0=1 (cases other than above)

select 1=0
(case of (PM(t−1, S0000)+BM(t,1)<PM(t−1, S1000)+BM(t, 2))

select 1=1 (cases other than above)

select 2=0
(case of (PM(t−1, S0001)+BM(t, 3)<PM(t−1, S1001)+BM(t, 4))

select 2=1 (cases other than above)

select 3=0
(case of (PM(t−1, S0110)+BM(t, 4)<PM(t−1, S1110)+BM(t, 5))

select 3=1 (cases other than above)

select 4=0
(case of (PM(t−1, S0111)+BM(t, 6)<PM(t−1, S1111)+BM(t, 7))

select 4=1 (cases other than above)

select 5=0
(case of (PM(t−1, S0111)+BM(t, 7)<PM(t−1, S1111)+BM(t, 8))

select 5=1 (cases other than above)

It is to be noted that this invention is not directly limited to the embodiments described above, and can be embodied in an implementation stage with modified components without departing from the spirit thereof. Further, various inventions can be formed by a proper combination of a plurality of components disclosed in the embodiments described above. For example, some components can be eliminated from all the components shown in the embodiment. Moreover, components in different embodiments can be properly combined.

As described above, in the recording/reproducing apparatus of the present invention, even when long-time recording, recording of a large number of titles or recording of a picture at a high encoding rate is performed in the DVD VR format on the DVD-R which is a write-once medium, editing can be performed under a certain range of conditions. Moreover, predetermined recording capacity which allows editing can be secured (set), thereby preventing a situation wherein the editing can not be performed after recording.

It is to be noted that this invention is not limited to the embodiments described above, and various modifications and changes can be made in an implementation stage of the invention without departing from the spirit thereof. Further, a proper combination of embodiments may be implemented as much as possible, in which case, effects by the combination can be provided.

What is claimed is:

1. An optical disk apparatus which has an adaptive equalizer supplied with at least an analog-to-digital-converted output of a reproduction signal, and a maximum likelihood decoder supplied with an output of the adaptive equalizer, to decode the reproduction signal from an information recording medium in which a reference information (VFO) area for a predetermined frequency is formed between a plurality of data (ECC block) areas set on a track, the optical disk apparatus comprising:
an optimum equalization coefficient storage section which stores an optimum equalization coefficient of the adaptive equalizer;
a pre-learning section which pre-learns whether or not a signal characteristic has been changed by use of at least data in the plurality of data areas, and obtains the optimum equalization coefficient of the adaptive equalizer for the data areas after the signal characteristic has been changed, and then stores the optimum equalization coefficient in the optimum equalization coefficient storage section;
a reference information (VFO) area detection section which detects that an area is the reference information (VFO) area; and
a preset control section which presets, on the basis of detection information on the predetermined frequency from the reference information (VFO) area detection section, at least the optimum equalization coefficient pre-learned in the reference information (VFO) area, and starts equalization coefficient learning processing for the adaptive equalizer at least after entering a next data area.

2. The optical disk apparatus according to claim 1, further comprising:
an optical head which reads recorded information in the information recording medium;
a waveform pre-equalizer supplied with the reproduction signal from the optical head, an offset control section supplied with an output of the waveform pre-equalizer, and an asymmetry control section supplied with an output of the offset control section;
an amplitude control section supplied with an output of the asymmetry control section;
an analog-to-digital converter supplied with an output of the amplitude control section;
the adaptive equalizer supplied with an output of the analog-to-digital converter; and
the maximum likelihood decoder supplied with the output of the adaptive equalizer,
wherein the pre-learning section further includes a function to pre-learn control information for one of the offset control section, the asymmetry control section and the amplitude control section, and the preset control section includes a function to preset the control information in the corresponding control section.

3. The optical disk apparatus according to claim 1, wherein
the reference information (VFO) area detection section includes a circuit which detects a predetermined frequency pattern in the reference information area.

4. The optical disk apparatus according to claim 2, wherein
the reference information (VFO) area detection section includes a circuit which detects a predetermined frequency pattern in the reference information area.

5. The optical disk apparatus according to claim 1, wherein
the reference information (VFO) area detection section includes an address reproduction circuit which processes a wobble signal of the track.

6. The optical disk apparatus according to claim 2, wherein
the reference information (VFO) area detection section includes an address reproduction circuit which processes a wobble signal of the track.

7. A reproduction method of an optical disk which uses an adaptive equalizer supplied with at least an analog-to-digital-converted output of a reproduction signal, and a maximum likelihood decoder supplied with an output of the adaptive equalizer, to decode the reproduction signal from an information recording medium in which a reference information (VFO) area for a predetermined frequency is formed between a plurality of data (ECC block) areas set on a track, the method comprising:
pre-learning whether or not a signal characteristic has been changed before decoding the reproduction signal by use of at least data in the plurality of data areas, obtaining the optimum equalization coefficient of the adaptive equalizer for the data areas after the signal characteristic has been changed, and storing the optimum equalization coefficient in the optimum equalization coefficient storage section;
detecting that an area is the reference information (VFO) area, during decoding of the reproduction signal; and
presetting, to the adaptive equalizer, at least the optimum equalization coefficient pre-learned in the reference information (VFO) area on the basis of detection information on the predetermined frequency from the reference information (VFO) area, and starting sequential equalization coefficient learning processing for the adaptive equalizer at least after entering a next data area.

8. The optical disk reproduction method according to claim 7, wherein
detection of the reference information (VFO) area is performed by detecting a predetermined frequency pattern in the reference information area.

9. The optical disk reproduction method according to claim 7, wherein
detection of the reference information (VFO) area is performed by processing a wobble signal of the track.
